(19) United States
(12) Patent Application Publication
(10) Pub. No.: US 2026/0337715 A1
(43) Pub. Date: Oct. 29, 2026

(54) ELECTROTHERMAL CHLORINATION AND CARBOCHLORINATION SYSTEMS AND METHODS FOR SELECTIVE METAL RECOVERY

(71) Applicant: William Marsh Rice University, Houston, TX (US)

(72) Inventors: James M. TOUR, Houston, TX (US); Bing DENG, Houston, TX (US); Wilbur Carter KITTRELL, Houston, TX (US); Shichen XU, Houston, TX (US); YI CHENG, Houston, TX (US)

(73) Assignee: WILLIAM MARSH RICE UNIVERSITY, Houston, TX (US)

(21) Appl. No.: 19/120,400

(22) PCT Filed: Oct. 12, 2023
(86) PCT No.: PCT/US2023/076707

§ 371 Date: Apr. 11, 2025

Related U.S. Application Data
(60) Provisional application No. 63/415,384, filed on Oct. 12, 2022.

(51) Int. Cl. C22B 4/04; C22B 11/02; C22B 25/06; C22B 34/32; C22B 47/00; C22B 58/00

(52) U.S. Cl. CPC C22B 4/04; C22B 11/021; C22B 25/06; C22B 34/32; C22B 47/00; C22B 58/00

(57) ABSTRACT

Metal recovery and separation systems and methods, and, more particularly, electrothermal chlorination (ETC) and electrothermal carbochlorination (ETCC) methods and systems for the selective metal extraction, such as extraction of critical metals from waste streams. Alternatively, other oxidants, such as fluorine, bromine, or iodine can be used in place of, or in addition to, chlorine. Further, alternatively, other reductants, such as metal(0) (like tin(0)) and H₂, (including H₂ in argon, such as between 1% and 5% H₂ by volume in argon) can be used in place of, or in addition to, carbon. Embodiments of the present invention can utilize ETC in selective recovery of In from ITO-containing wastes and ETC coupled with ETCC for Ta recovery from capacitor waste.

### CROSS-REFERENCED TO RELATED PATENT APPLICATIONS

The application is related to U.S. Patent Appl. Ser. No. 63/415,384, entitled “Metal Recovery And Separation Systems And Methods,” filed Oct. 12, 2023, to James M. Tour, et al., which patent application is commonly owned by the owner of the present invention and is incorporated herein in its entirety.

This application is also related to U.S. patent application Ser. No. 18/263,831, entitled “Ultrafast Flash Joule Heating Synthesis Methods And Systems For Performing Same,” filed Aug. 1, 2023, to James M. Tour et al. (“Tour '831 Application”), which is the US § 371 nationalization of PCT Patent Appl. Serial No. PCT/US22/14923, entitled “Ultrafast Flash Joule Heating Synthesis Methods And Systems For Performing Same,” filed Feb. 2, 2022, to James M. Tour et al., claiming priority to U.S. Patent Appl. Ser. No. 63/144,862, filed Feb. 2, 2021, all of which patent applications are commonly owned by the owner of the present invention The Tour '831 Application is incorporated herein in its entirety.

### GOVERNMENT INTEREST

This invention was made with government support under Grant No. R1A330-416000, awarded by the United States Air Force Office of Scientific Research, Grant No. W912HZ-21-2-0050, awarded by the United States Engineer Research and Development Center for the United States Army Corp of Engineers, and Grant No. HR00112290122, awarded by the Defense Advanced Research Projects Agency, United States Department of Defense. The government has certain rights in the invention.

### TECHNICAL FIELD

The present invention relates to metal recovery and separation systems and methods, and, more particularly, electrothermal chlorination and electrothermal carbochlorination methods and systems for the selective metal extraction, such as extraction of critical metals from waste streams.

### BACKGROUND

There is urgent and increasing demand for metals for applications on electronics, superalloys, and renewable energy systems. [Reck 2012; Sovacool 2020]. Metals are infinitely recyclable, in principle. However, current metal recycling is often inefficient because of restrictions on social behavior, product design, and recycling technologies. The recovery of critical elements from electronic waste (e-waste), among the class of urban mining, is important for a circular economy by simultaneously preventing critical materials supply chain disruption while mitigating the environmental impact of waste disposal. It is estimated that more than 45 million tons of e-waste are produced each year and are growing at ~9% per year. [Ghosh 2015]. E-waste has become an enormous environmental problem since it contains heavy metals and plastics. [Ogunseitan 2009]. However, e-waste is also a valuable resource since it has a high content of valuable metals [Chauhan 2018], including base metals (such as Cu, Al, and Fe), precious metals (such as Au, Ag, and Pt), rare earth metals (Sc, Y, and La group), and critical metals (such as Ga, In, Ta) that are essential for electronics platforms but presently hard to acquire due to political and economic controls.

Critical metals, including Ga, In, and Ta, find widespread applications in semiconductor, display, and capacitor technologies and thus are essential for modern electronics. For example, tantalum (Ta) is widely used as tantalum capacitors in cellular phones and computers. [Matsuoka 2004]. The price of Ta increases sharply as the production rate of Ta is limited. Therefore, the recovery of Ta from e-waste is essential for achieving a sustainable Ta supply chain. For Ga, its production is estimated to be ~270 tons in 2012. [Salazar 2013].

Ga is traditionally recovered from the byproduct of alumina and zinc production. [Dutrizac 2000; Fang 1996]. The increasing demand of Ga requires the search of new resources and extraction method. Ga is mostly used as semiconductors in electronics in the form of gallium arsenide (GaAs), and some portion of gallium nitride (GaN), aluminum gallium indium phosphide (AlGaInP), aluminum gallium arsenide (AlGaAs) among others. The recovery of Ga from e-waste would compensate for the increasing consumption of Ga in consumer electronics.

For In, it is also a rare metal, and is mostly recovered from by-product residues during the production of lead and zinc. Currently, In is mostly used to produce indium-tin oxide (ITO) thin films, which possess simultaneous transparency and conductivity, and thus is the critical component of transparent electrodes in displays, touch screens, photovoltaics, and smart windows. As the demand for personal electronics increases, the consumption of In is undergoing a sharp increase. Hence, the recovery of In from consumer electronics scrap is critical for a sustainable In supply chain.

Chlorination processes are used in extractive metallurgy for metal separations, which has been used industrially to separate titanium (Ti) from its ores. [Jena 1997]. By reaction of various metals or metal compounds with chlorinating agents to form metal chlorides, the differences in properties like volatility and solubility of metal chlorides permit the separation of metals. [Xing 2020]. Commercially, the chlorination is conducted using a fluidized bed [Niu 2013], which typically operates at 900 to 1300 °C. [Gleser '353 Patent]. The available temperature range limits its wide application. As a result, the chlorination process is applied in a few scenarios like Ti and magnesium (Mg). [Xing 2020]. In addition, the sluggish heating and cooling processes inevitably reduce the efficiency of the chlorination process.

Likewise, rare earth elements (REE) are critical materials in modern electronics, clean technologies, alloys and catalysts. [Cheisson 2019]. Concentrated aqueous acid leaching of the REE minerals followed by biphasic solvent extraction has been the dominant scheme for REE mass production. [Cheisson 2019]. While REE minerals are not rare, their separation one from the other remains very difficult. Mining from natural ores has several difficulties: (1) A low value mixed rare earths concentrate is generated that is 60-70% Ce and La, both of which have near zero value, and they impede the isolation of the more desired critical REEs, including Nd, Pr, Dy, Tb and Sc; (2) Iron, silicon, and aluminum oxides impede high recoveries and clean product; (3) The co-concentration of actinides is highly troublesome. Uranium (U) can be sold, but Thorium (Th) is produced 3:1 compared to U. Th and U enrichment beyond certain levels is illegal in the US. Back blending into tailings is an environmental burden. If a process recovers the lanthanides while leaving the actinides in the feedstock, that would be significant, but there is presently no such solution.

Therefore, if a technology can selectively recover Nd, Pr, Dy, Tb and Sc while leaving behind Ce and La, as well as the actinides and other impurities, that would be highly advantageous.

REE separation is generally classified as primary separation (the separation of REE from other impurity elements), and secondary separation (the separation of individual REE). [Xie 2014]. The presence of metal impurities in the REE-containing leachate affects the subsequent REE separation efficiency by methods such as solvent extraction and ion exchange. [Xie 2014; Judge 2020; Zhang 2021] Hence, the impurities usually need to be removed prior to the REE separation. [Judge 2020].

The composition of ores and secondary wastes often differ significantly from one source to another, and hence the impurities in the leachate also vary significantly in types and contents. [Judge 2020]. The major impurities include Al, Si, Fe, Ca, Mg, Zn, Co, Ni, Cr, Cu, among others. Many techniques, including solvent extraction, ion exchange or adsorption, and selective precipitation, have been widely used to remove the impurities in leach liquor. [Judge 2020]. The applicable route significantly depends on the impurities type and content, and the target application of REE. For example, for the Fe-containing solution, acidic extractants such as di-(2-ethylhexyl)phosphoric acid (D2EHPA) can selectively extract REE with appropriate extractant concentration and organic/aqueous ratio. [Ye 2019]. For Al impurity, a significant amount can be removed through selective precipitation by adjusting the pH of the leach liquor. [Silva 2019]. Ca and Mg impurities usually do not co-extract with REE with the upper tolerance limit being 1500 ppm. [Li 2019]. Thus, Ca and Mg are not particularly problematic in REE extraction. For Cu and Zn, they do not usually co-extract with REE during cation solvent extraction or ion exchange. [Li 2019; Lou 2019].

For the secondary separation, ion exchange or solvent extraction is the most appropriate commercial technology for REE separation. [Gupta 1992]. Because the chemical properties of rare earth ions in aqueous solution are similar, the degree of separation for the solvent extraction process is often very poor, usually with a separation factor at each stage of only 2 to 10. [Adachi 1999]. Hence, up to hundreds of stages of mixer and settler may be assembled to achieve the necessary separation and purity of REE. [Xie 2014]. In addition, the ion exchange process is not suitable for industrial production because of the very long periods required for significant separation. [Uda 2000].

### SUMMARY OF THE INVENTION

The present invention relates to metal recovery and separation systems and methods, and, more particularly, electrothermal chlorination and electrothermal carbochlorination methods and systems for the selective metal extraction, such as extraction of critical metals from waste streams.

In general, in one embodiment, the invention features a method for selectively recovering at least one metal of two or more metals from a material. The method includes mixing a material with an oxidant to form a mixture. The material includes two or more metals. The method further includes perform a flash Joule heating process on the mixture. The method further includes separating and selecting recovering at least one or more first metals of the two or more metals of the material from at least one or more second metals of the two or more metals of the material.

Implementations of the invention can include one or more of the following features:

The oxidant can be selected from the group consisting of chlorine agents, fluorine agents, bromine agents, iodine agents, and combinations thereof.

The oxidant can include a chlorine agent.

The chlorine agent can be selected from the group consisting of halide salts, ammonium chloride, and combinations thereof.

The chlorine agent can be sodium chloride.

The chlorine agent can be Cl₂.

The flash Joule heating process can include an electrothermal chlorination process.

The flash Joule heating process can be performed at a temperature between 630 °C and 830 °C.

The first one or more metals can include In.

The flash heating process can be performed at a temperature greater than 1240 °C.

The first one or more metals can include a metal selected from the group consisting of Sn and Mn. The second one or more metals can include a metal selected from the group consisting of Au and Cr.

The step of performing a flash Joule heating process on the mixture can include a first flash Joule heating process performed at a first temperature on the mixture to form a first product. The step of performing a flash Joule heating process on the mixture can include a first evaporation process is performed on the first product to form a first residue product. The step of performing a flash Joule heating process on the mixture can include a second flash Joule heating process performed at a second temperature on the first residue product.

The second temperature can be greater than the first temperature.

The first flash Joule heating process can include a first electrothermal chlorination process. The second flash Joule heating process can include a second electrothermal chlorination process.

The first flash Joule heating process can be performed at a temperature between 630 °C and 830 °C. The second flash Joule heating process can be performed at a temperature greater than 1240 °C.

The first evaporative process can form an evaporative phase.

The evaporative phase can include a compound that includes In.

The first residue product can include a compound that includes a metal selected from the group consisting of Sn, Mn, Au, and Cr.

The second flash Joule heating process can form a second product.

A second evaporation process can be performed on the second product to form a second residue product.

The second residue product can include a compound that includes a metal selected from the group consisting of Au and Cr.

The second evaporation process can form a second evaporative phase.

The second evaporative phase can include a compound that includes a metal selected from the group consisting of Sn and Mn.

The step of performing a flash Joule heating process on the mixture can include the second flash Joule heating process forms a second residue product. The step of performing a flash Joule heating process on the mixture can include a second evaporation process is performed on the second product to form a second residue product. The step of performing a flash Joule heating process on the mixture can include a third flash Joule heating process performed at a third temperature on the second residue product.

The second temperature can be greater than the first temperature. The third temperature can be greater than the second temperature.

The material can be a waste.

The waste can be post-consumer electronic waste.

The waste can be post-industrial waste.

The post-industrial waste can be selected from the group consisting of coal fly ash, bauxite residue, ores, mining tailings, and dredge muds.

The e waste can include indium-tin oxide (ITO).

The waste can be electrode waste.

The electrode waste can include a compound selected from the group consisting of In₂O₃, SnO₂, Au, MnO, Cr₂O₃, and combinations thereof.

The mixture can further include a reductant.

The reductant can be selected from the group consisting of carbon sources, metal(0) sources, H₂, and combinations thereof.

The reductant can include a metal(0) source.

The metal(0) source can include a tin(0) source.

The reductant can include the H₂.

The reductant can include the H₂ in argon or nitrogen (N₂).

The reductant can include between 1% and 5% of the H₂ by volume in the argon or the nitrogen (N₂).

The reductant can include a carbon source.

The flash Joule heating process can include an electrothermal carbochlorination process.

The flash Joule heating process can form a first product. A first evaporation process can be performed on the first product to form a first residue product. The method can further include mixing a reductant to the first residue product to form a second mixture. The method can further include performing a second flash Joule heating process on the second mixture.

Before the step of performing the second flash Joule heating process, the method can perform a treatment on the first residue product. The treatment can be selected from the group consisting of an aqueous treatment, an aqueous acid treatment, and an aqueous base treatment.

The treatment of the first residue product can increase purity of one or more metals recovered from the first residue product.

The reductant can be selected from the group consisting of carbon sources, metal(0) sources, H₂, and combinations thereof.

The reductant can include a metal(0) source.

The metal(0) source can include a tin(0) source.

The reductant can include the H₂.

The reductant can include the H₂ in argon or nitrogen (N₂).

The reductant can be between 1% and 5% of the H₂ by volume in the argon or the nitrogen (N₂).

The reductant can include a carbon source.

The flash Joule heating process on the mixture can include an electrothermal chlorination process. The second flash Joule heating process on the second mixture can include an electrothermal carbochlorination process.

The first evaporative process can form a first evaporative phase.

The first evaporative phase can include a compound that includes a metal selected from the group consisting of Fe, Ni, Mn, Cu, and combinations thereof.

The first residue product can include a compound that includes a metal selected from the group consisting of Si, Ta, and combinations thereof.

The second flash Joule heating process can form a second product.

A second evaporation process can be performed on the second product to form a second residue product.

The second residue product can include a compound that includes Ta.

The second evaporation process can form a second evaporative phase.

The second evaporative phase can include a compound that includes Si.

The material can be a waste.

The waste can be post-consumer electronic waste.

The waste can be post-industrial waste.

The post-industrial waste can be selected from the group consisting of coal fly ash, bauxite residue, ores, mining tailings, and dredge muds.

The waste can include Ta.

The waste can be capacitor waste.

The capacitor waste can include compounds selected from the group consisting of Fe₂O₃, NiO, MnO, CuO, SiO₂, Ta₂O₅, and combinations thereof.

The method can selectively recover the at least one metal of the two more metals from a material with a selectivity of at least 70 wt % purity of the at least one metal.

The selectivity can be at least 90 wt %.

The selectivity can be at least 95 wt %.

The selectivity can be at least 97 wt %.

The selectivity can be at least 99 wt %.

The selectivity can be at least 99.999 wt %.

In general, in another embodiment, the invention features a system for selectively recovering at least one metal of two or more metals. The system includes a source of the mixture that includes a material and an oxidant. The material includes two or more metals. The system further includes a cell operably connected to the source such that the mixture can be flowed into the cell and held under compression. The system further includes electrodes operatively connected to pressure cell. The system further includes a flash power supply for applying a voltage across the mixture to perform a flash Joule heating process on the mixture. The system is configured and operable to perform any of the above-described methods to separate and selectively recover at least one or more first metals of the two or more metals of the material from at least one or more second metals of the two or more metals of the material.

Implementations of the invention can include one or more of the following features:

The source of the mixture can include the material, the oxidant, and a reductant.

The system can include a second source that includes a reductant.

### BRIEF DESCRIPTION OF THE DRAWINGS

FIGS. 1A-1H show thermodynamics and setup of an electrothermal chlorination method. FIG. 1A shows critical reaction temperature (T_{crit}) of chlorination and carbochlorination for various metal oxides. FIG. 1B shows a schematic of the electrothermal chlorination process where the metal chlorides or metal oxychlorides vaporize and deposit on the quartz tube. FIG. 1C shows a current profile at 60 V, resistance of ~1Ω, and pulse 1 duty cycle of 10%. Inset of FIG. 1C is enlarged current profile. FIG. 1D are pictures of the carbon paper heater before (upper) and during (lower) electric heating. FIG. 1E shows temperature profiles of carbon paper heater under different voltage inputs. FIG. 1F shows maximum temperature and heating/cooling rates of the carbon paper heater under different voltage inputs. FIG. 1G shows simulated average temperature profiles of the sample and gas. Inset of FIG. 1G shows the simulated cross-sectional temperature distribution at t=0.6 s and 4 s. FIG. 1H shows correlation of sample and gas temperature versus the carbon paper heater temperature (Tₕₑₐₜₑᵣ).

FIG. 2 is a scheme of an electrothermal chlorination and carbochlorination system.

FIGS. 3A-3B show an electrical supply system. FIG. 3A shows an electric diagram of the system. FIG. 3B show a picture of the electrical supply system.

FIGS. 4A-4B show geometry and boundary conditions for the simulation. FIG. 4A shows 3D framework of the simulation configuration. FIG. 4B shows cross-section of the simulation.

FIG. 5 shows simulated temperature distribution at different time, ranging from 0.1 s to 4 s.

FIG. 6 shows simulated temperature distribution at t=4 s under different carbon heater temperatures (Tₕₑₐₜₑᵣ).

FIGS. 7A-7I show selective recovery of In from ITO-containing wastes. FIG. 7A shows calculated ΔG versus temperature for chlorination of In₂O₃ and SnO₂. FIG. 7B shows maximum temperature (Tₘₐₓ) of the carbon paper heater versus voltage input with the duty cycle of 5%. FIG. 7C is a picture of the ITO raw material (bottom), the volatile (middle), and the residue (top). FIG. 7D shows Raman spectra of the ITO raw material, InCl₃ volatile product, and SnO₂ residue. FIG. 7E shows XRD patterns of the ITO raw material (PDF #01-089-4597), InCl₃ volatile product (PDF #01-0170), and SnO₂ residue (PDF #00-021-1250). FIG. 7F shows purity and yield of the product versus voltage input. FIG. 7G shows major metal composition in the TCE wastes. FIG. 7H shows ΔG of chlorination reaction versus temperature for main components in the TCE wastes, including In₂O₃, MnO, SnO₂, Au, and Cr₂O₃. The dash line denotes ΔG=0 kJ mol⁻¹. FIG. 7I shows recovery yield and purity of In from the TCE waste. The error bars in FIGS. 7F, 7G, and & I denote the standard deviation where N=3.

FIG. 8 shows temperature profiles of the carbon paper heater under different voltage inputs.

FIGS. 9A-9B show chlorination of In₂O₃ by ETC process. FIG. 9A are pictures of the In₂O₃ raw materials placed on carbon paper heater (bottom) and the InCl₃ volatiles deposited on the quartz tube. FIG. 9B are Raman spectra of the In₂O₃ raw materials, commercial InCl₃, and the as-obtained InCl₃ volatiles.

FIG. 10 shows a protocol for the separation of In from the TCF wastes.

FIGS. 11A-11B show separation of In from TCF waste by ETC process. FIG. 11A shows elemental composition of the raw materials and the volatile under different voltage input. FIG. 11B shows elemental composition of the raw materials and the residue under different voltage input.

FIGS. 12A-12I show selective recovery of Ta from Ta capacitor waste. FIG. 12A shows major metals present in the Ta capacitor waste. FIG. 12B shows ΔG of the chlorination reaction versus temperature for major metals in Ta capacitor waste, including Ta₂O₅, SiO₂, CuO, Fe₂O₃, NiO, and MnO. FIG. 12C shows ΔG of the carbochlorination reaction versus temperature for Ta₂O₅ and SiO₂. FIG. 12D shows kinetics of the carbochlorination of Ta₂O₅ and SiO₂. The slope of the fitted curves according to the Arrhenius equation is the activation energy of the reaction where the activation energies are SiO₂=53.6 kJ mol⁻¹ and Ta₂O₅=31.6 kJ mol⁻¹. FIG. 12E shows EDS spectra of the first-step volatile (bottom) and the second-step volatile (top). Insets of FIG. 12E are the pictures of the volatiles condensed on the quartz tube; step 1 chlorination lower inset and step 2 carbochlorination upper inset. FIG. 12F shows metal content percentages in Ta capacitor raw materials, step 1 volatile and residue, and step 2 volatile and residue. FIG. 12G shows product purity and yield under different electrothermal chlorination and carbochlorination conditions. The first row denotes the first step ETC parameters, and the second row denotes the second step ETCC parameters. FIG. 12H shows XRD patterns of the as-deposited volatiles and that after calcination. The reference PDF of Ta₂O₅ is shown (01-082-9637). FIG. 12I shows Raman spectra of the Ta₂O₅ raw materials, as-deposited volatiles, and that after calcination. The error bars in FIGS. 12A and 12G denote standard deviation where N=3.

FIGS. 13A-13B show chlorination of Ta₂O₅ by ETC process. FIG. 13A shows pictures of the Ta₂O₅ raw materials (bottom) and the sample after chlorination. FIG. 13B shows XRD pattern of the residue after ETC process.

FIGS. 14A-14C show carbochlorination of Ta₂O₅ by ETCC process. FIG. 14A shows pictures of the mixture of TaO₅ with C (bottom) and the volatile deposited on the quartz tube after the ETCC process. FIG. 14B shows XRD patterns of the as-deposited volatiles on the quartz tube and the volatiles after calcination at 800 °C. FIG. 14C shows Raman spectra of Ta₂O₅ raw materials, as-deposited volatiles, and that after calcination.

FIGS. 15A-15C show carbochlorination of the mixture of Ta₂O₅ and SiO₂ by ETCC process. FIG. 15A shows pictures of the mixture of Ta₂O₅, SiO₂, and C (bottom), and the volatiles deposited on the quartz tube after the ETCC process (top). FIG. 15B shows XRD patterns of the as-deposited volatiles on the quartz tube and that after calcination. FIG. 15C shows Raman spectra of the Ta₂O₅ raw materials, as-deposited volatiles, and the sample after calcination.

FIG. 16 shows a protocol for the separation of Ta from the Ta capacitor waste by two-step ETC and ETCC process. Note that a brief rinsing step with water before Step 2 can remove small amounts of the residual metal chlorides from the desired Ta₂O₃ and SiO₂.

FIGS. 17A-17E show characterization of the first step ETC volatile and residue. FIG. 17A shows XRD patterns of the TCW raw materials, the residue, and the volatile. FIG. 17B shows EDS spectrum of the residue. FIG. 17C shows EDS spectrum of the volatiles. FIG. 17D shows an SEM image and EDS elemental maps of the residue. FIG. 17E shows an SEM image and EDS elemental maps of the volatile.

FIGS. 18A-18C show characterization of the second step ETCC residue. FIG. 18A shows XRD pattern of the residue. FIG. 18B shows EDS spectrum of the residue. FIG. 18C shows an SEM image and EDS elemental maps of the residue.

FIGS. 19A-19F show scaling rules and scale-up demonstration. FIG. 19A shows pictures of carbon paper heaters under the same voltage input of 100 V, with sizes of 2×6 cm², 3×9 cm², and 4×12 cm² (W/L) (S=2, 3, 4, respectively). FIG. 19B shows the carbon paper heater temperature map versus voltage input and carbon heater length. The carbon paper heater aspect ratio is fixed to 3. FIG. 19C shows simulated average temperature profile of samples with different carbon heater scales. The carbon heater temperature is fixed to 1200 °C. Inset of FIG. 19C shows simulated temperature distribution for S=2 and 4. FIG. 19D shows time of T₉₉ and the sample mass varied with carbon paper heater scale. FIG. 19E shows picture of the raw capacitor waste placed on the carbon heater with size of 3×9 cm² (top) and the volatiles deposited on the quartz tube after the second-step ETCC reaction (bottom). FIG. 19F shows purity and yield of the Ta product recovered from the scaled-up batch.

FIG. 20 shows a simulation of the temperature distribution of different scale at t=4 s for 2D scale-up. The carbon paper heater temperature is fixed at 1200 °C.

FIG. 21 shows a simulation of the temperature distribution of the upscaled sample (S=4) at different time varying from 1 s to 60 s. The carbon heater temperature is fixed at 1200 °C.

FIGS. 22A-22C show a 3D scale-up of the ETC process. FIG. 22A shows simulated temperature distribution at different scales. FIG. 22B shows simulated average temperature profile of sample with different carbon heater scale. The carbon paper heater temperature is fixed to 1200 °C. FIG. 22C shows time of T₉₉ and the normalized sample mass varied with carbon heater scale.

FIGS. 23A-23B show scaling up of the ETC process for In separation from ITO. FIG. 23A shows pictures of the ITO raw materials (top) and the volatile deposited on the quartz tube (bottom). FIG. 23B shows purity and yield of In product in different batches.

FIGS. 24A-24F show scaling up of the two-step process for Ta recovery from TCW. FIG. 24A shows pictures of the TCW raw materials (top), and the volatiles deposited on quartz tube obtained in the first-step chlorination process (bottom). FIG. 24B shows pictures of the mixture of the first-step residue and C (top), and the volatiles deposited on quartz tube obtained in the second-step carbochlorination process (bottom). FIG. 24C shows XRD patterns of the second-step as-deposited volatile and that after calcination. FIG. 24D shows Raman spectra of the second-step as-deposited volatile and that after calcination. FIG. 24E shows EDS spectrum of the second-step as-deposited volatiles. FIG. 24F shows SEM image and EDS elemental maps of the volatiles.

### DETAILED DESCRIPTION

The present invention relates to metal recovery and separation systems and methods, and, more particularly, electrothermal chlorination and electrothermal carbochlorination methods and systems for the selective metal extraction, such as extraction of critical metals from waste streams.

As used herein “selective” or “selectivity” means the method/system recovers and separates the metal (or group of metals) into a component having at least 70 wt % purity of the metal (or group of metals). In some embodiments, the selectivity can be at least 90 wt % purity, in further embodiments, the selectivity can be at least 95 wt % purity, in further embodiments, the selectivity can be at least 97 wt % in purity, in further embodiments, the selectivity can be at least 99 wt % in purity, and, in still further embodiments, the selectivity can be at least 99.999% purity.

### Electrothermal Chlorination And Carbochlorination

Embodiments of the present invention include innovative electrothermal chlorination and carbochlorination methods and systems for the selective extraction of critical metals from waste streams. Such methods and systems utilize programmable, pulsed current input to provide precise control over temperature and reaction duration during the chlorination process. This level of control can be utilized to achieve both thermodynamic and kinetic selectivity for the desired metals. These methods and systems have broad applicability, including, for example, selectively in recovering indium from waste materials containing indium tin oxide and tantalum from waste tantalum capacitors. Furthermore, these methods and systems can be scaled. With its compact reactor design and rapid treatment capabilities, this method provides a variety of applications in metal recycling, refining, and process intensification.

### Thermodynamics And Setup

Thermodynamic analysis was performed for the chlorination of 34 metal oxides using chlorine (Cl₂) as the chlorinating agent, covering representative metals in s, p, and d blocks. The thermodynamic analysis was conducted using the software HSC Chemistry 10. Direct chlorination of metal oxides was considered with the below reaction:

MOₓ+xCl₂=MCl₂ₓ+x/2O₂ (1)

Carbochlorination of metal oxides was considered with the below reaction:

MOₓ+xCl₂+xC=MCl₂ₓ+xCO (2)

The calculation was conducted under standard pressure of 1 atm. The 34 metal oxides and their corresponding chlorides, covering representative metals in s, p, and d blocks, included Li₂O/LiCl, Na₂O/NaCl, K₂O/KCl, BeO/BeCl₂, MgO/MgCl₂, CaO/CaCl₂), B₂O₃/BCl₃, Al₂O₃/AlCl₃, Ga₂O₃/GaCl₃, In₂O₃/InCl₃, SiO₂/SiCl₄, GeO₂/GeCl₄, SnO₂/SnCl₄, PbO/PbCl₂, TiO₂/TiCl₄, ZrO₂/ZrCl₄, HfO₂/HfCl₄, V₂O₅/VCl₅, Nb₂O₅/NbCl₅, Ta₂O₅/TaCl₅, Cr₂O₃/CrCl₃, MoO₃/MoCl₅, WO₃/WCl₆, MnO/MnCl₂, Fe₂O₃/FeCl₃, CoO/CoCl₂, NiO/NiCl₂, PdO/PdCl₂, PtO₂/PtCl₂, CuO/CuCl₂, Ag₂O/AgCl, ZnO/ZnCl₂, CdO/CdCl₂, and HgO/HgCl₂. The thermodynamic favorability of the direct chlorination reaction is first considered; if it is not favorable, the carbochlorination reaction is considered where the carbon reduces the metal oxide to, for example, a lower valent metal oxide or metal(0) that can the react with the chlorine to form a desired metal chloride. Alternatively, other oxidants, such as fluorine, bromine, or iodine can be used in place of, or in addition to, chlorine. Further, alternatively, other reductants, such as metal(0) (like tin(0)) and H₂, (including H₂ in argon or nitrogen (N₂), such as between 1% and 5% H₂ by volume in argon or nitrogen (N₂)) can be used in place of, or in addition to, carbon. The mixture having less than 5% H₂ in argon is below the explosive limit of H₂, so this is safer.

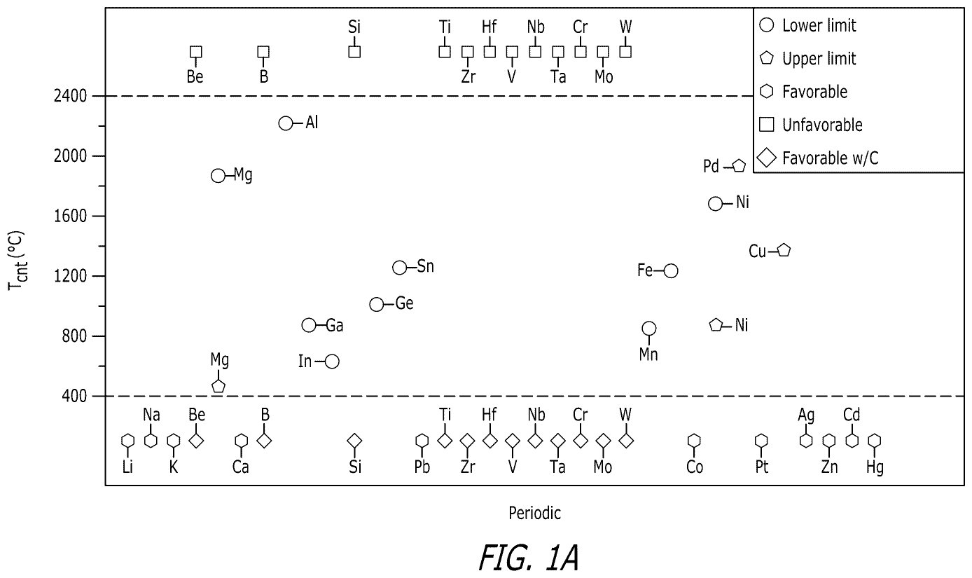

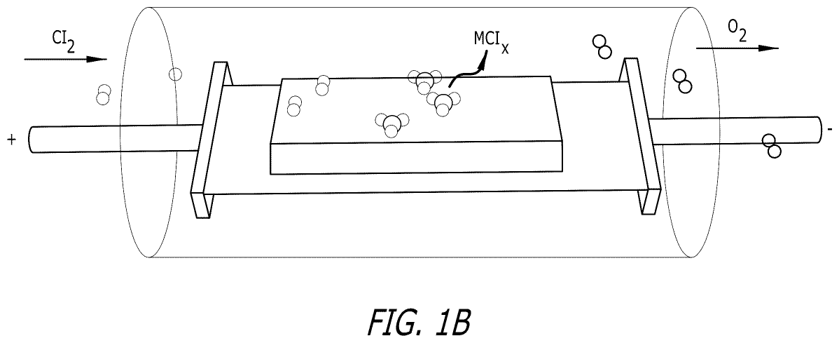

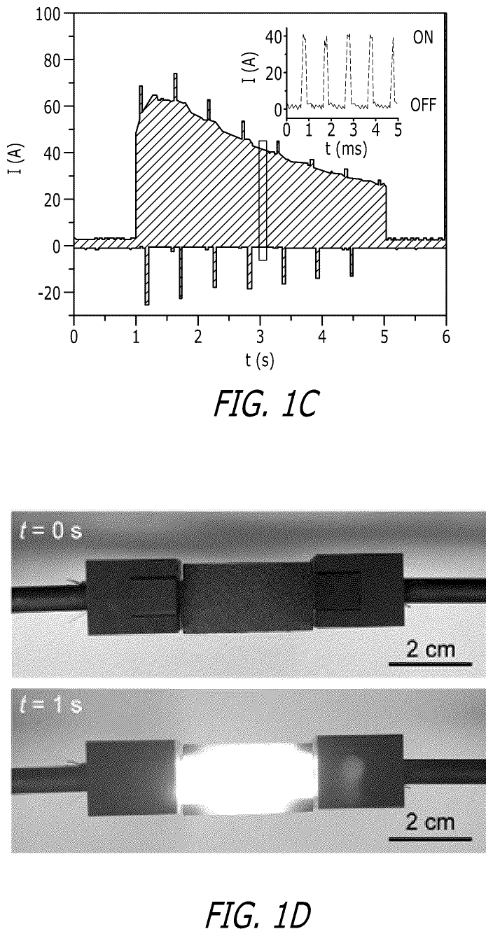

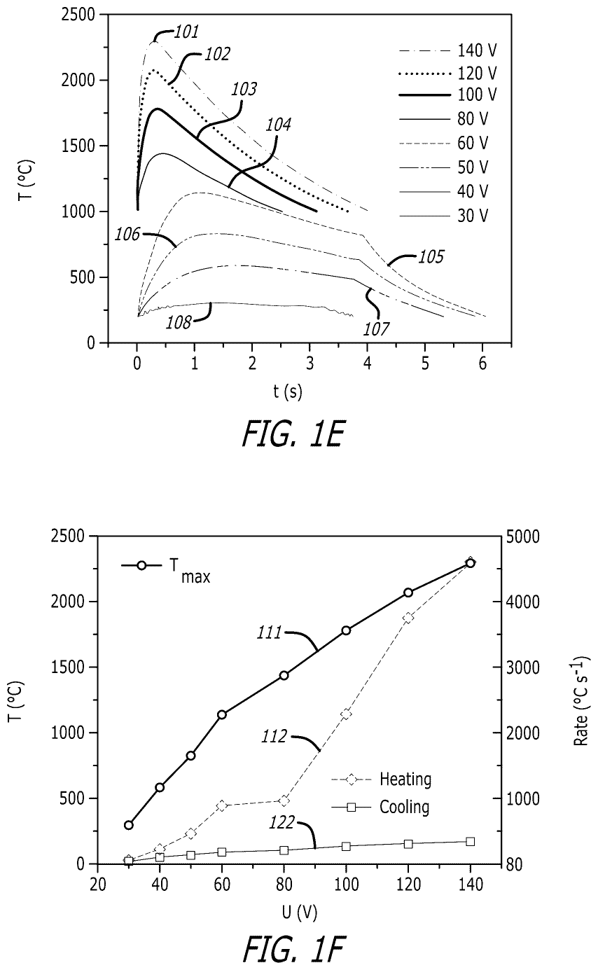

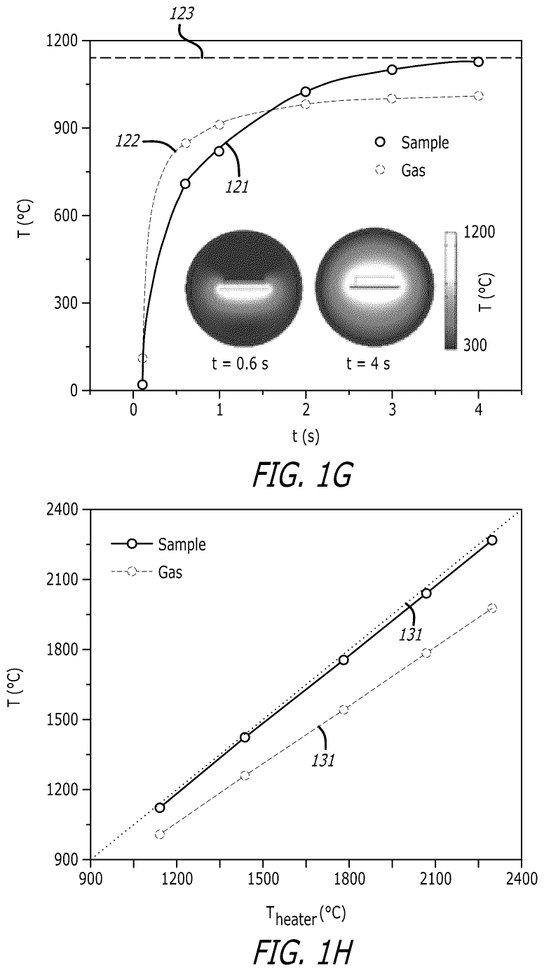

These metals can be categorized into a few groups, as shown in FIG. 1A, shows critical reaction temperature (T_{crit}) of chlorination and carbochlorination for various metal oxides:
(i) The direct chlorination is favorable at any temperature >0 °C: Li, Na, K, Ca, Pb, Co, Pt, Ag, Zn, Cd, and Hg.
(ii) The direct chlorination is favorable only at temperature higher than a specific value (lower limit): Mg (1870 °C), Al (2220 °C), Ga (875 °C), In (630 °C), Ge (1010 °C), Sn (1250 °C), Mn (830 °C), Fe (1230 °C), and Ni (1680 °C).
(iii) The direct chlorination is favorable only at temperature lower than a specific value (upper limit): Mg (460 °C), Ni (870 °C), Pd (1930 °C), Cu (1370 °C).
(iv) The direct chlorination is unfavorable at any temperature: Be, B, Si, Ti, Zr, Hf, V, Nb, Ta, Cr, Mo, W.
(v) The carbochlorination is favorable at any temperature >0 °C: Be, B, Si, Ti, Zr, Hf, V, Nb, Ta, Cr, Mo, W.

Both the chlorination reaction Eq. (1) and carbochlorination reaction Eq. (2) were calculated, and these reactions can be categorized into four groups:
(i) The chlorination reaction is favorable under any temperature.
(ii) The chlorination reaction is favorable with a lower limit temperature threshold.
(iii) The chlorination reaction is favorable with an upper limit temperature threshold.
(iv) The chlorination reaction is unfavorable under any temperature but their carbochlorination reactions are favorable, where carbon acts as a reductant and the reduced metal is reactive with chlorine.

This analysis pinpointed the limits of the conventional chlorination reaction. First, the temperature required for chlorination reactions could range from 400 to 2400 °C, so many metal oxides cannot be chlorinated using a conventional heating methods that generally operate under 1500 °C. Secondly, the reaction temperature difference is narrow among metal oxides, calling for precise temperature control to secure the selectivity based on reactivity differences. Thirdly, for chlorination reactions with the same trend in reactivity, it is unable to separate them based solely on thermodynamics.

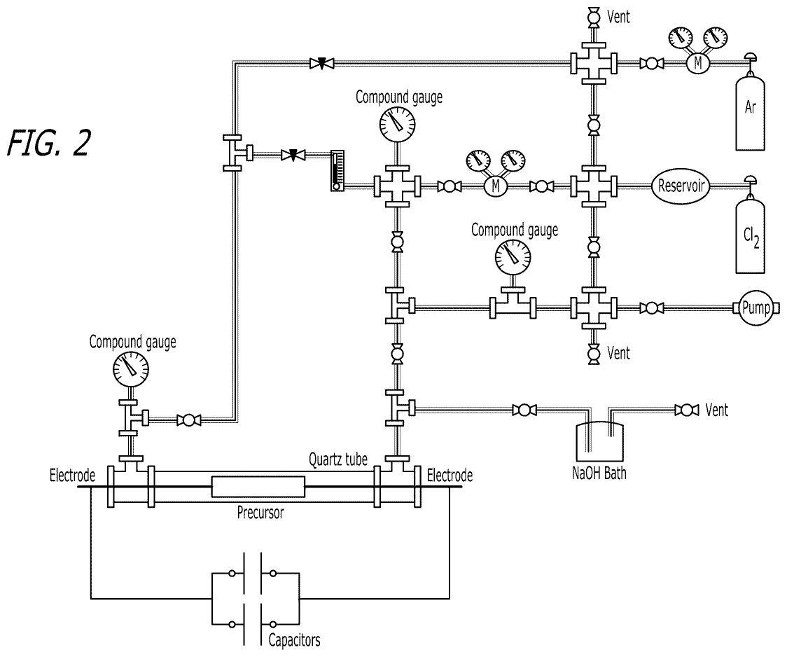

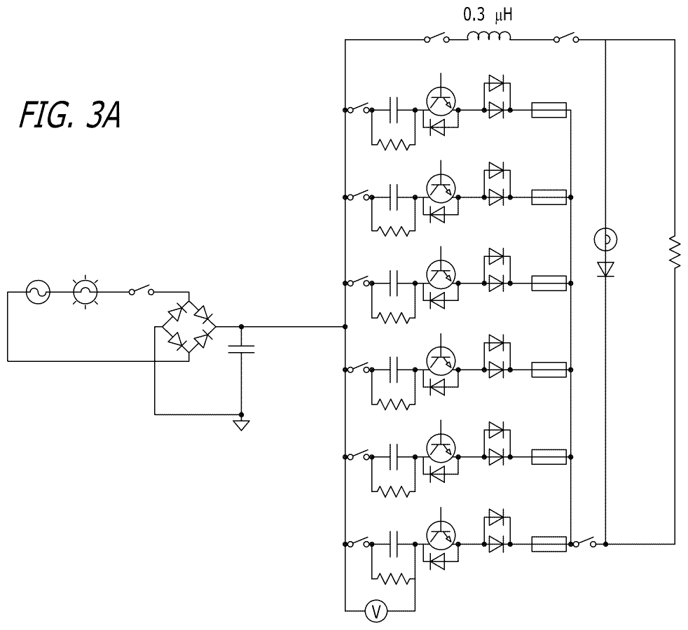

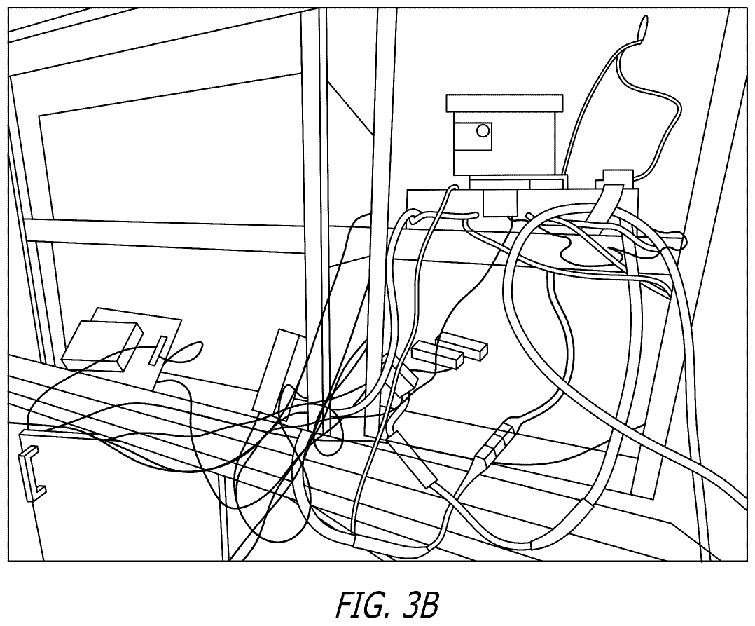

To address these obstacles, direct electric heating can be utilized for the electrothermal chlorination (ETC) or electrothermal carbochlorination (ETCC). See FIG. 1B-1H; FIG. 2. Distinct from a conventional furnace that heats the sample through thermal convection, the metal oxide precursors were loaded on a carbon paper heater and heated through thermal conduction. An electrical system, as shown in FIGS. 3A-3B, was used to deliver programmable direct current input to a carbon paper heater (FIG. 1C), which enables its rapid heating and cooling (FIG. 1D). The temperature of the carbon paper heater could be precisely regulated by changing the voltage input, achieving a wide temperature distribution from 400 to 2500 °C. FIG. 1E (with plots 101-108 for 140V, 120V, 100V, 80V, 60V, 50V, 40V, and 30V, respectively).

The diagram of the electrical system to generate pulsed direct current is shown in FIGS. 3A-3B. A capacitor bank that can reach voltages up to 500 V with a total capacitance of 0.624 F was used. The capacitor was charged by a DC supply. A variable-frequency drive (VFD) was used to generate the pulse voltage with the frequency (f) ranging from 0 to 1000 Hz (and generally in the experiments described herein f=1000 Hz was used). The duty cycle (or the ON state period) is tunable (and generally in the experiments described herein, the duty cycle of 5% or 10% was used). The current profile was recorded using a Multifunction I/O (NI USB-6009) controlled by Lab View. The carbon paper was used as the heater, which was secured on graphite block and connected to electric system through two graphite electrodes. For the carbon paper with size of 1 cm×3 cm, the resistance is ~0.7Ω, which is appropriate for the Joule heating.

The ETC process exhibited some unprecedented features, addressing the limits of conventional furnace heating-based chlorination processes. First, the high temperature up to 2500 °C permits the chlorination reaction of almost all metal oxides (FIG. 1A), greatly broadening the applicability of the chlorination process. Secondly, the precise temperature controllability by tuning the voltage input of the electrothermal process (FIG. 1F, with plots 111-113 for Tₘₐₓ, heating, and cooling, respectively) enables the separation of metals with a narrow reaction window. Thirdly, the ultrafast heating (up to ~4500 °C s⁻¹) and cooling (~500 °C s⁻¹) rates (FIG. 1F) lead to the use of kinetic selectivity based on reaction rate and activation energy differences among the reactions with similar thermodynamics.

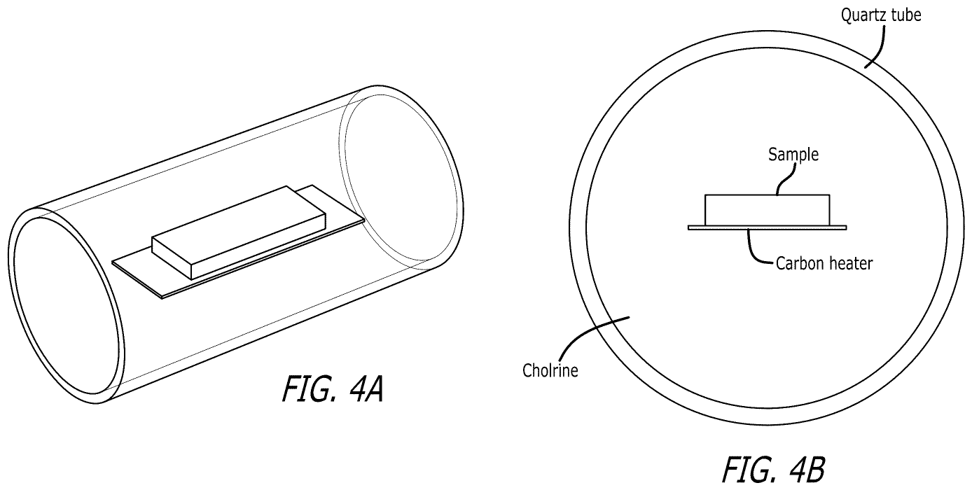

In the electrothermal chlorination configuration, the metal oxide precursors and Cl₂ gas were heated by the carbon paper heater. A simulation was conducted to assess the details of the sample and gas heating process. A primary purpose of this simulation was to assess how the sample and gas temperature was correlated with the carbon paper heater temperature. The numerical simulation was conducted based on the finite element method (FEM) using the software COMSOL Multiphysics 5.5. Heat transfer in solid and fluids interface in Heat Transfer module was used with the time dependent study. The geometric configuration, materials parameters, and boundary conditions are shown in FIG. 4A-4B and TABLES I-II.

TABLE I
Geometry Parameters For The Simulation

| Components | Shape | Size |
|---|---|---|
| Quartz tube | Tube | Length: 5*S cm; Radius: 1.2*S cm; Thickness: |
| | | 0.1 cm |
| Chlorine | Cylinder | Length: 5*S cm; Radius: (1.2*S − 0.1) cm |
| Carbon paper | Film | Length: 3*S cm; Width: 1*S cm; Thickness: |
| | | 0.019 cm |
| Sample | Cuboid | Length: (3*S − 1) cm; Width: (1*S − 0.2) cm; |
| | | Thickness: 0.21*S cm |

Note:
S is the scale factor, representing the size of the simulation, where S = 1, 2, 3, 4 were used in this study.

TABLE II
Materials Parameters

| | Heat capacity | Density | Thermal conductivity |
|---|---|---|---|
| Materials | (J kg⁻¹ K⁻¹) | (kg m⁻³) | (W m⁻¹ K⁻¹) |
| Quartz | 156.8049 + | 2672.472 − | 8.0 |
| | 1.899827 × T + | 0.1655731 × T + | |
| | 0.0018682 × T² − | 9.434743 × 10⁻⁴ × | |
| | 7.115139 × 10⁻⁶ × | T² − 3.391169 × | |
| | T³ + 4.927861 × | 10⁻⁶ × T³ + | |
| | 10⁻⁹ × T⁴ for T | 4.850933 × 10⁻⁹ × | |
| | between 293-800K; | T⁴ − 2.511325 × | |
| | 17825.62 − | 10⁻¹² × T⁵ for T | |
| | 45.58418 × T + | between 73-873K; | |
| | 0.03107743 × T² for | 2534.9 for T | |
| | T between 800- | between 873- | |
| | 847K; | 1773K; | |
| | 1118.642 + | 2836.051 − | |
| | 0.0465529 × T for T | 0.4594262 × T + | |
| | between 847-2000K | 1.748683 × 10⁻⁴ × | |
| | | T² for T between | |
| | | 1373-1773K | |
| Graphite | 720 | 2260 | 828.7378 − |
| | | | 1.019662 × T + |
| | | | 0.001249675 × T² − |
| | | | 8.986835 ×10⁻⁷ × |
| | | | T³ + 3.26994 × |
| | | | 10⁻¹⁰ × T⁴ − |
| | | | 4.424554 × 10⁻¹⁴ × |
| | | | T⁵ for T between |
| | | | 239-1690K; |
| | | | 408.9712 − |
| | | | 0.008605539 × T for |
| | | | T between 1690- |
| | | | 2100K |
| ITO | 357.4 | 7000 | 4 |
| Chlorine | −284512.0 × T² + | 926.8965 × T⁻¹ for | −0.005399155 + |
| | 36.90288 + 2.5104 × | T between 239- | 7.247257 × 10⁻⁵ × |
| | 10⁻⁴ × T for T | 3000K | T − 1.33837 × |
| | between 239-3000K | | 10⁻⁷ × T² + |
| | | | 2.091404 × 10⁻¹⁰ × |
| | | | T³ − 1.251233 × |
| | | | 10⁻¹³ × T⁴ for T |
| | | | between 239-3000K |

Note:
The temperature-dependent functions are built-in in the materials library of COMSOL.

The geometry of all parts resembled real experiments. The temperature of the quartz tube wall was set at 320 °C based on the experimental measurements during the chlorination reaction. The inflow gas temperature was set at room temperature (20 °C), and pressure at 1 atm. The flow rate of Cl₂ was estimated to be 10 sccm. The maximum temperatures of the carbon paper heater with voltage input of 60, 80, 100, 120, and 140 V (FIG. 1E-1F) were experimentally measured. These values were used as the input of carbon paper heater temperature, and time-dependent heater transfer was conducted for the simulation, to obtain the temperature distribution. Simulation was conducted at four scales with scaling factor(S) of 1, 2, 3, 4. S=1 represents the mostly used experimental conditions, and a larger S represents the upscaled experiments.

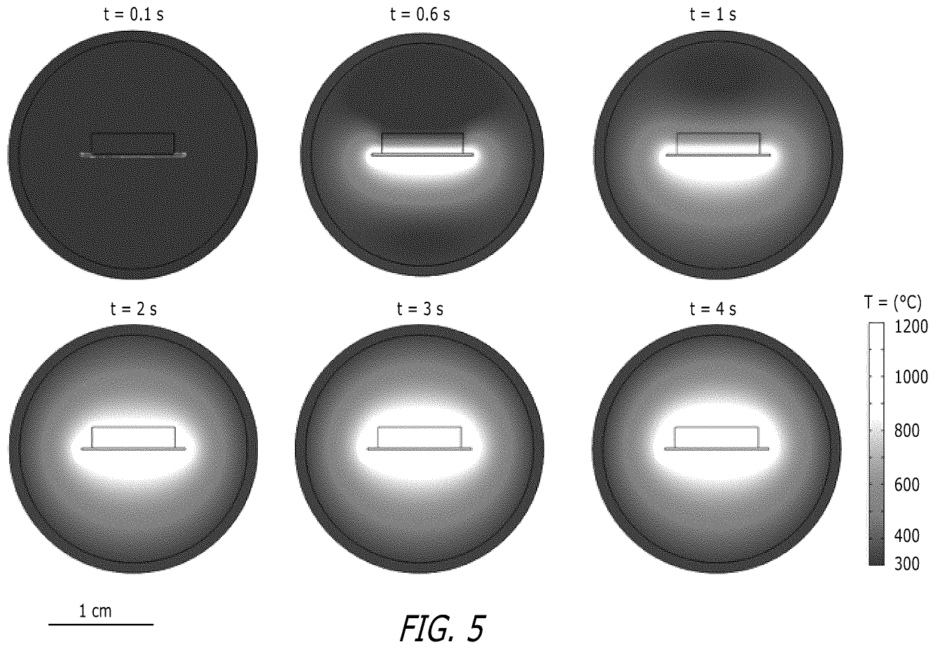

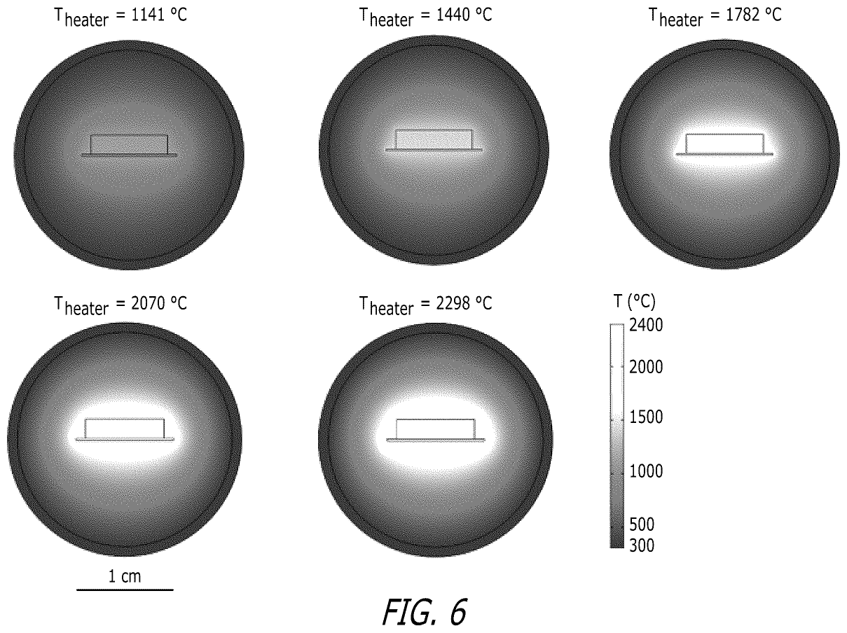

The carbon paper heater temperature was fixed at Tₕₑₐₜₑᵣ=1141 °C, which is the experimentally measured value under voltage input of U=60 V. FIG. 1F. The sample temperature is defined as the average temperature of the sample; and the gas temperature is defined as the average temperature of the gas within the diameter of carbon paper width, considering that only the gas close to the sample reacts. It was found that the sample and gas temperatures reached the plateau (~1141 °C) at ~4 s, (FIG. 1G (with plots 121-122 for sample and gas, respectively, and dash line 123 denoting the carbon paper heater temperature, which is fixed at 1141 °C); FIG. 5), demonstrating the rapid sample and gas heating capability of the electrothermal process. This is distinct from the traditional indirect heating process that could take hours to reach thermal balance. In addition, by changing the Tₕₑₐₜₑᵣ, the sample and gas temperatures closely follow Tₕₑₐₜₑᵣ pattern (FIG. 1H (with plots 131-132 for sample and gas, respectively); FIG. 6), proving the precise controllability of the reaction temperature. (It was found that the sample and gas temperatures follow the pattern of the carbon paper heater temperature closely.)

In a typical small-scale experiment, the carbon paper size of 1×3 cm² was used for the sample mass of 100 mg. The sample was loaded on a carbon paper heater, which was connected to the capacitor bank. The sample was put into a sealed quartz tube. After purging the system for 3 times, Cl₂ was introduced at a flow rate of ~20 sccm for small-scale sample, and ~40 sccm for large-scale sample. The pulse current input brings the carbon paper heater to a desired temperature. The sample and gas temperatures follow the patterns of heater rapidly, as shown in FIG. 1G. The volatiles were deposited on the quartz tube. The chloride product was usually deliquescent, so the sample sealed in the quartz tube was transferred into the glove box, and the sample was then collected. The detailed experimental conditions for the experiments are shown in TABLE III.

TABLE III
Reaction Conditions For The Chlorination And Carbochlorination

| | Weight of raw | Voltage | Duty | Time | Yield | Purity |
|---|---|---|---|---|---|---|
| Raw materials | materials (mg) | (V) | cycle (%) | (s) | (%) | (wt %) |
| In₂O₃ | 100 | 100 | 5 | 20 | NA | NA |
| ITO | 100 | 90 | 5 | 30 | 57.6 | 98.3 |
| | 100 | 100 | 5 | 30 | 94.8 | 98.4 |
| | 100 | 110 | 5 | 30 | 91.0 | 98.9 |
| | 100 | 120 | 5 | 30 | 91.3 | 95.2 |
| ITO | 1000 | 110 | 10 | 120 | 90.5 | 98.0 |
| TCF waste | 30 | 100 | 5 | 30 | 52.4 | 73.0 |
| | 30 | 105 | 5 | 30 | 92.1 | 95.0 |
| | 30 | 110 | 5 | 30 | 90.5 | 87.9 |
| Ta₂O₅ | 100 | 100 | 5 | 30 | NA | NA |
| Ta₂O₅:C (2:1, | 30 | 100 | 5 | 12 | NA | NA |
| m:m) | | | | | | |
| SiO₂:C (2:1, | 30 | 110 | 5 | 12 | NA | NA |
| m:m) | | | | | | |
| Ta₂O₅:SiO₂:C | 30 | 80-110 | 5 | 12 | NA | NA |
| (2:2:1, m:m:m) | | | | | | |
| TCW: 1^{st} ETC | 100 | 130 | 5 | 40 | 92.2 | 64.6 |
| TCW: 2^{nd} ETCC | 1^{st} residue, C | 110 | 5 | 40 | | |
| TCW: 1^{st} ETC | 100 | 130 | 5 | 40 | 90.2 | 76.3 |
| TCW: 2^{nd} ETCC | 1^{st} residue, C | 100 | 5 | 40 | | |
| TCW: 1^{st} ETC | 100 | 130 | 5 | 60 | 87.8 | 95.8 |
| TCW: 2^{nd} ETCC | 1^{st} residue, C | 100 | 5 | 40 | | |
| TCW: 1^{st} ETC | 1000 | 150 | 10 | 120 | 58.6 | 95.1 |
| TCW: 2^{nd} ETCC | 1^{st} residue, C | 110 | 10 | 240 | | |

Note:
TCE, transparent conductive films; TCW, tantalum capacitor wastes.

### In Recovery From ITO-Containing Waste

The recovery of critical metals in real-world wastes was next tested, exemplified by In recovery from ITO-containing waste and Ta recovery from Ta capacitor wastes.

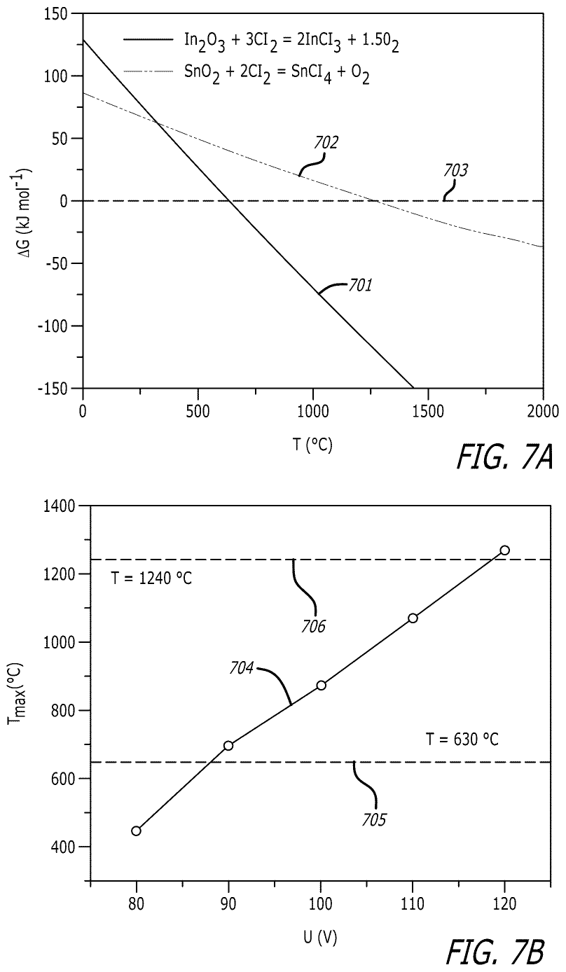

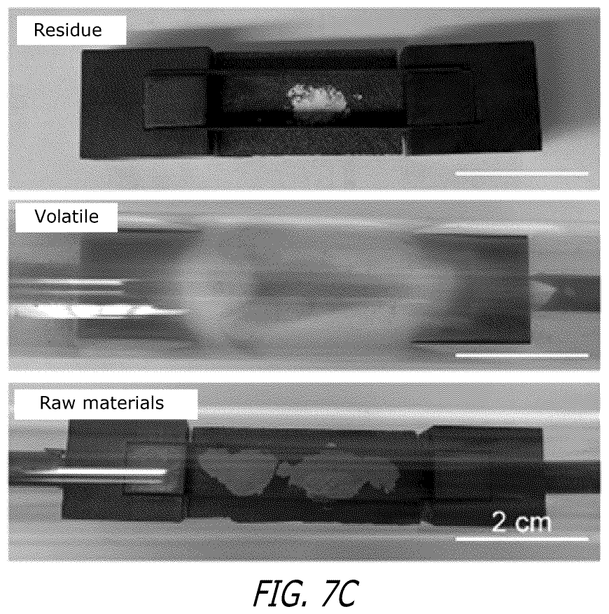

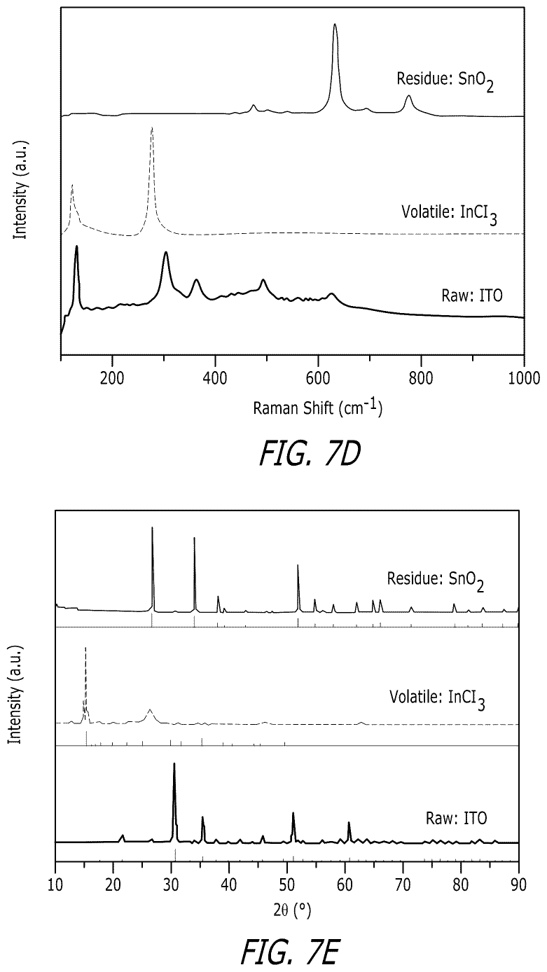

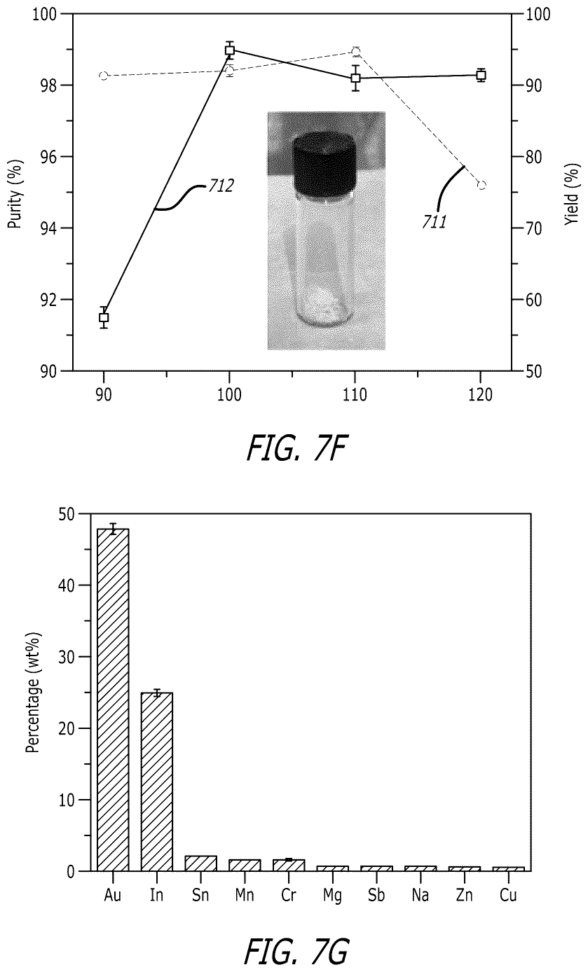

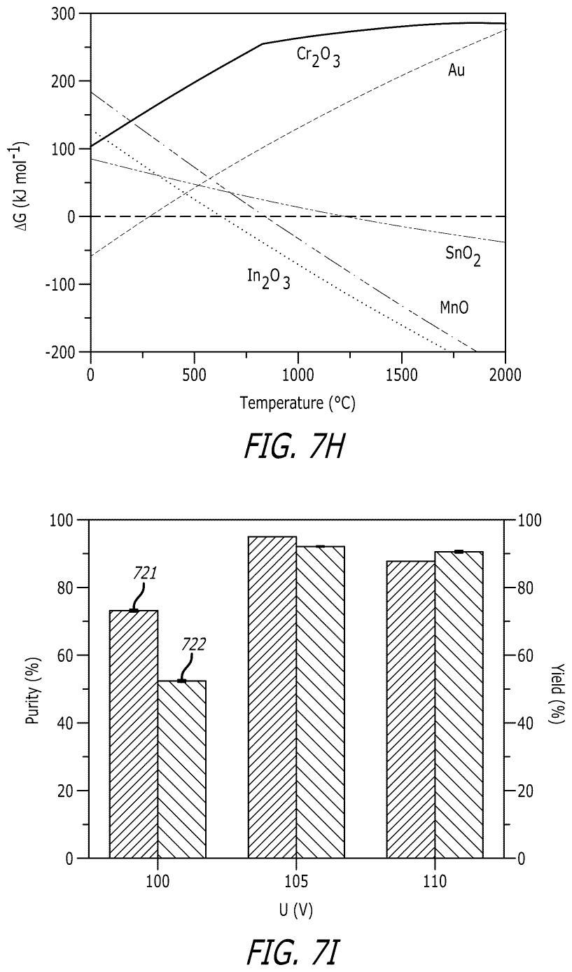

In is a critical metal, which has no minerals of its own and thus is generally produced as a byproduct from other metallurgical processes especially zinc (Zn) and copper (Cu). [Frenzel 2017]. In is considered as technology-critical element and is used mainly as indium tin oxide (ITO), which serves as the main waste for In recycling. [Virolainen 2011]. ITO is composed of 90% In and 10% tin(Sn). The thermodynamics were analyzed for the chlorination reaction of In₂O₃ and SnO₂ using Cl₂ as the chlorinating agent. FIG. 7A (with plots 701-702 for chlorination of In₂O₃ and SnO₂, respectively, and dash line 703 denotes ΔG=0 kJ mol⁻¹). A temperature window from 630 to 1240 °C enables the conversion of In₂O₃ to InCl₃ while SnO₂ remains unreacted.

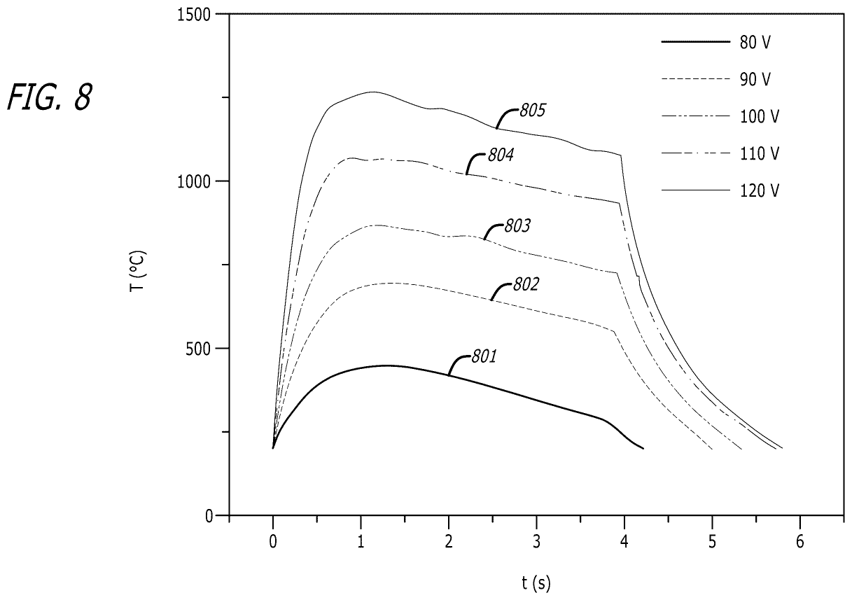

InCl₃ can then be evaporated as the volatile phase, thus separating it from SnO₂ based on their volatility difference. The above temperature window corresponds to the voltage input between 90 to 110 V. FIG. 7B (plot 704 with the bottom dash line 705 and top dash line 706 denote T=630 °C and 1240 °C, respectively); FIG. 8 (with plots 801-805 for 80V, 90V, 1000V, 110V, and 120V, respectively.

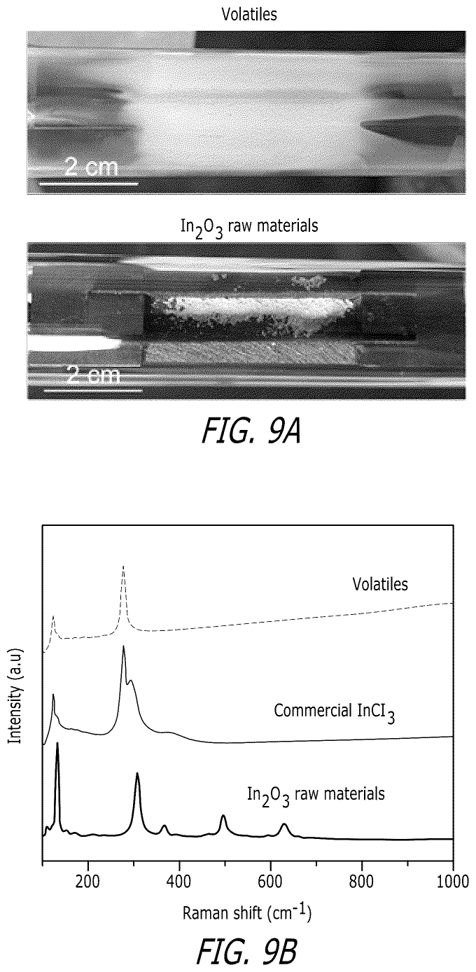

Firstly, by controlling the voltage input at 100 V, the feasibility was shown for conversion of In₂O₃ to InCl₃ by the ETC process. FIGS. 9A-9B. Then, the ITO was used as precursor. After the ETC process, the volatile condensate was obtained on the quartz tube with the residue remaining on carbon paper heater. FIG. 7C. X-ray diffraction patterns and Raman spectra showed that the volatiles are InCl₃ while the residue is SnO₂. FIGS. 7D-7E.

The effect of voltage input was investigated on the purity and yield of the product. FIG. 7F (with bars 711-712 for purity and yield, respectively). As voltage increased, the yield was improved due to the more complete reaction; however, excessive voltage input at 120 V led to the significantly reduced purity because of the concurrent chlorination of SnO₂. FIG. 7B. The optimized result exhibits purity of 99% and yield of 91% for In product. FIG. 7F.

Next, a real-world waste, the transparent conductive films (TCF), was investigated for In recovery. After removing the plastic substrates by calcination, a metal mixture was obtained that primarily composed of Au, In, Sn, Mn, etc. Total quantification shows that In accounts for ~30 wt % among the metal content. FIG. 7G. The five metals were considered with content>1 wt %, including Au, In, Sn, Mn, and Cr. Computational thermodynamic analysis of the chlorination reaction was conducted on Au, In₂O₃, SnO₂, MnO, and Cr₂O₃. FIG. 7H.

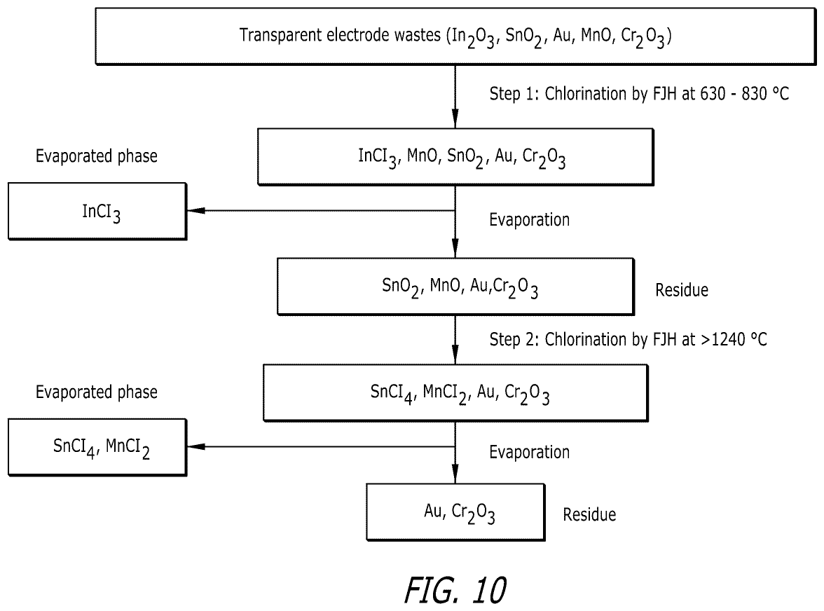

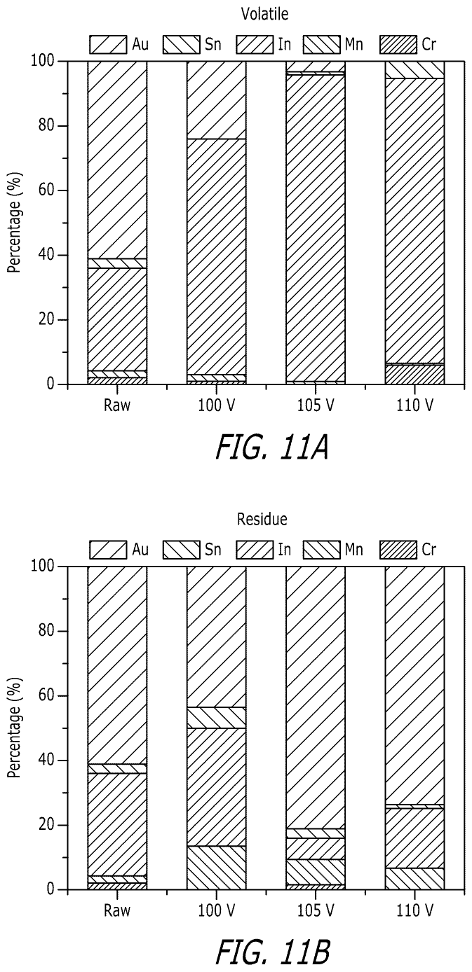

The temperature window was 630 °C to 830 °C, under which only In₂O₃ can be chlorinated and separation from other metals by evaporation. FIG. 10. The effect of voltage on the In recycling performance was investigated since the voltage is critical for In recovery. FIG. 7I; FIGS. 11A-11B. If the voltage is relatively low at 100 V, it results in an inadequately low temperature wherein Au can also be chlorinated, leading to the low purity of the In product. If the voltage is too high at 110 V, SnO₂ and MnO are also chlorinated and mixed with the desired In product. With the appropriate voltage of 105 V, an overall performance was obtained of 95% purity and 92% yield of In. FIG. 7I. This demonstrates the pivotal role of precise temperature control for the selective recovery of metals, which is an advantage and benefit of the electrothermal process. All of this was afforded without the use of water or acid, so there are no tailing or secondary liquid wastes.

### Ta Recovery From Ta-Containing Waste

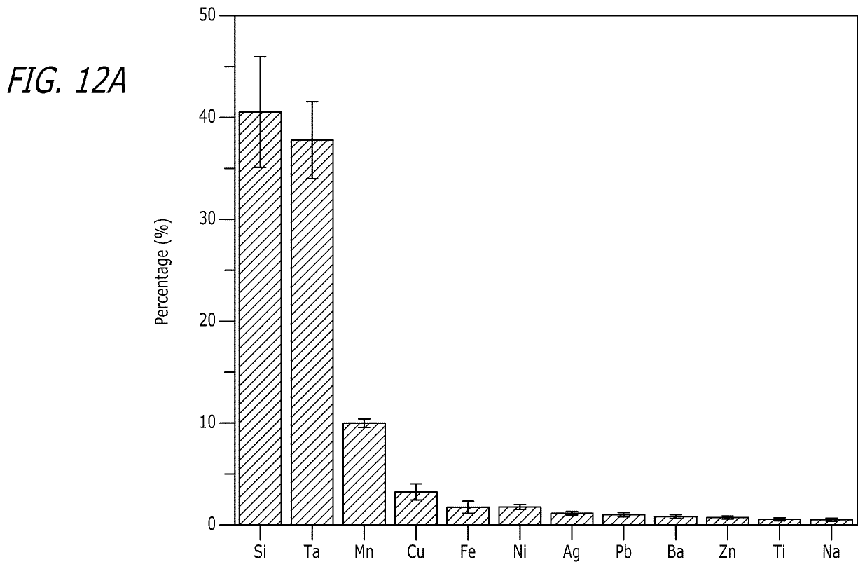

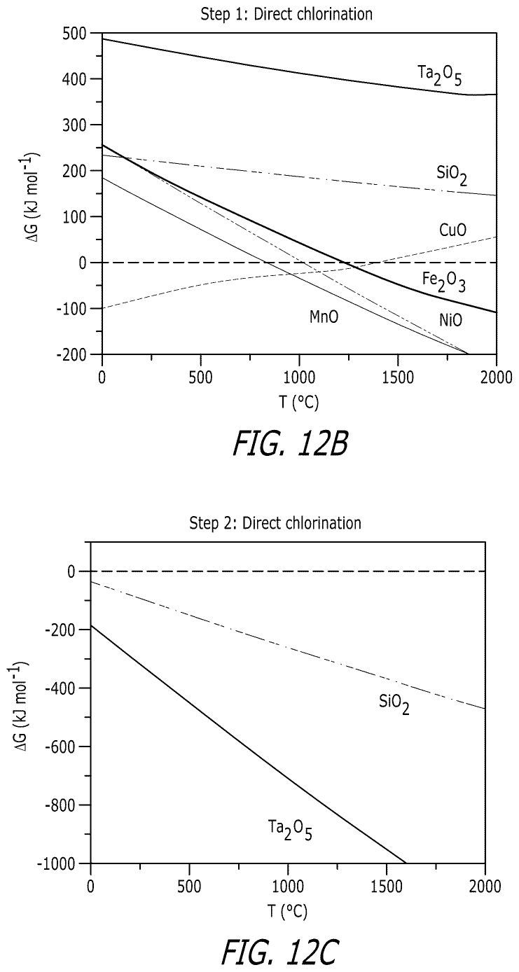

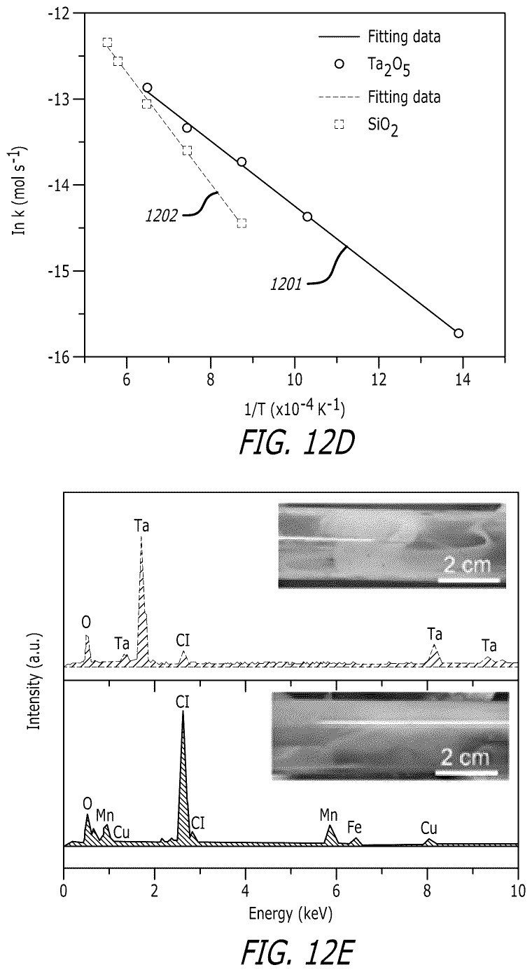

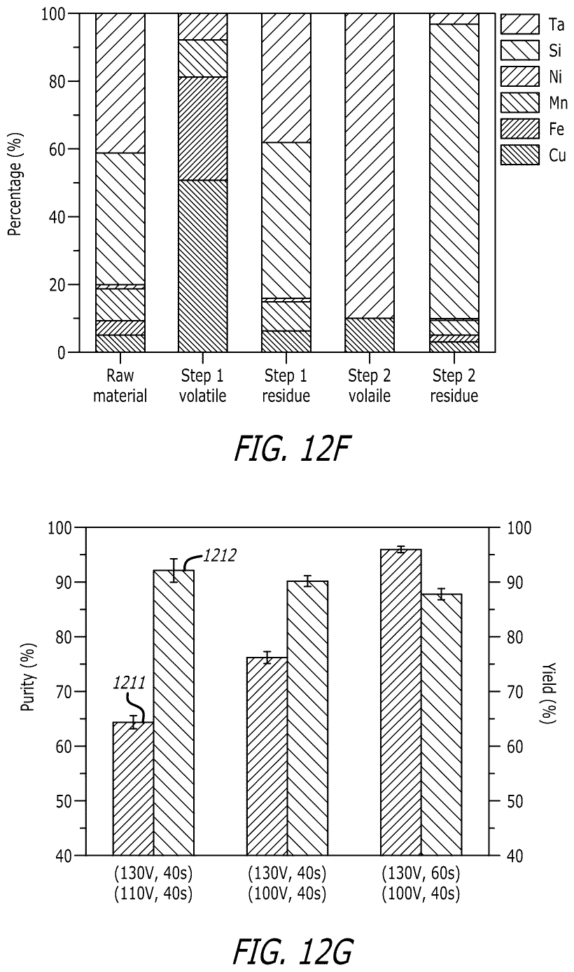

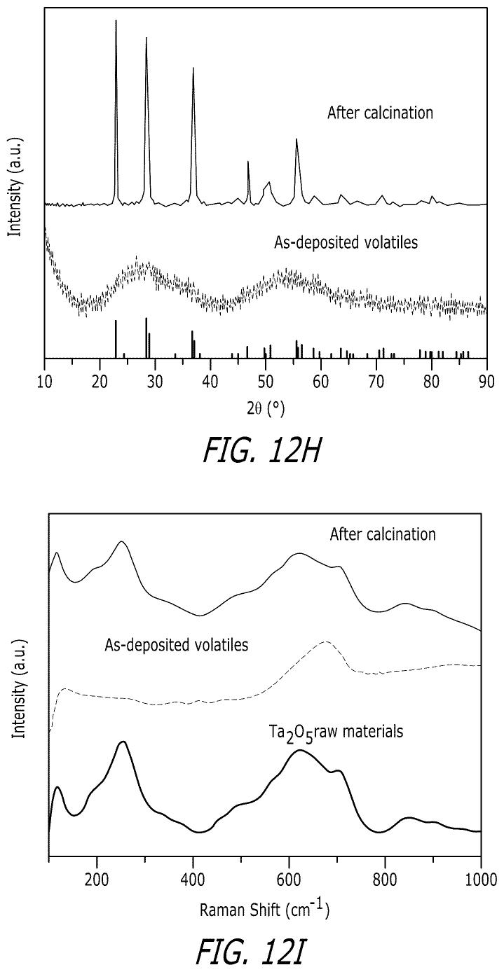

Ta is another technology-critical metal that is used primarily in electronics as capacitors or in superalloys. [Agrawal 2021]. The annual global production of Ta is ~2000 tons and 42% of Ta is consumed in manufacturing Ta capacitors. [Angerer 2013]. Waste Ta capacitors exits widely in small electrical appliances, and they contain a Ta content as high as 45 wt %, thus they are a high-grade Ta resource. [Niu 2017]. Here, the Ta capacitor wastes (TCW) were subjected to calcination in air to remove the plastic and resin layers. Afterward, a fine yellow powder was obtained that was composed of various metal oxides including tantalum pentoxide (Ta₂O₅). Total quantification was conducted of metals in the powder after digestion followed by ICP-MS measurement. FIG. 12A. The mass ratio of Ta in the waste is ~37.8 wt %, with other main metal compositions (>1 wt %) including Si, Mn, Cu, Fe, and Ni.

The thermodynamics were first computationally analyzed for the chlorination reactions of these metal oxides with Cl₂. FIG. 12B (with the dashed line denoting ΔG=0 kJ mol⁻¹). These metal oxides are categorized into two groups. The first group is CuO, Fe₂O₃, NiO, and MnO, whose chlorination reactions are thermodynamically favorable under a specific temperature threshold (upper limit for CuO, and lower limits for Fe₂O₃, NiO, and MnO). The second group metals include Ta₂O₅ and SiO₂, whose chlorination reactions are thermodynamically unfavorable.

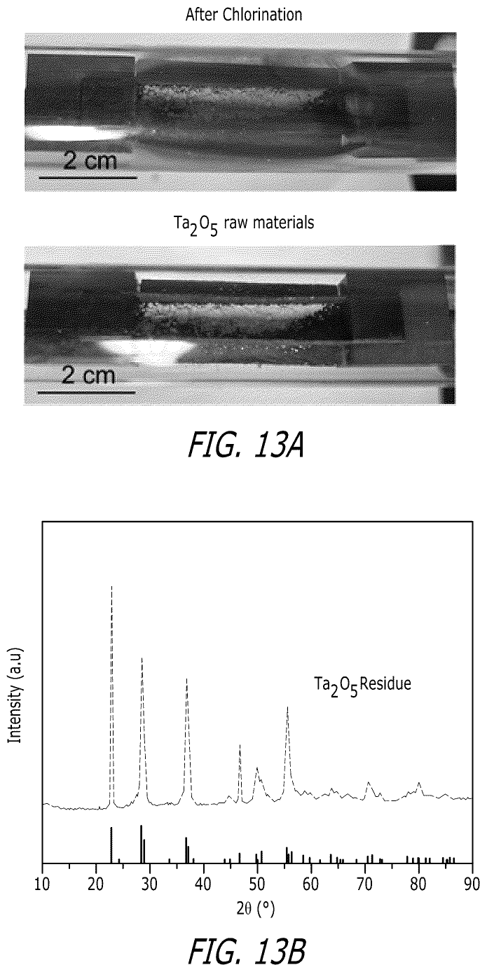

Chlorination was experimentally conducted of Ta₂O₅ with Cl₂, which does not react (FIGS. 13A-13B), aligning well with the theoretical analysis. Hence, for Ta₂O₅ and SiO₂, the thermodynamics were analyzed for their carbochlorination reactions (FIG. 12C, with the dashed line denoting ΔG=0 kJ mol⁻¹), which shows that both are favorable under the temperature range investigated. Nevertheless, the large difference in Gibbs free energy change (ΔG) between SiO₂ and Ta₂O₅ indicates possible kinetic selectivity for their separation.

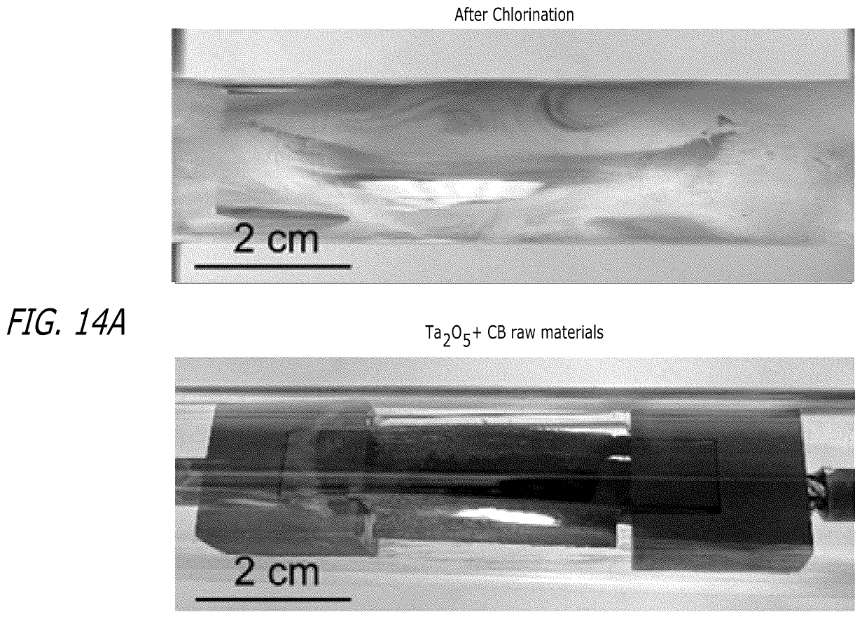

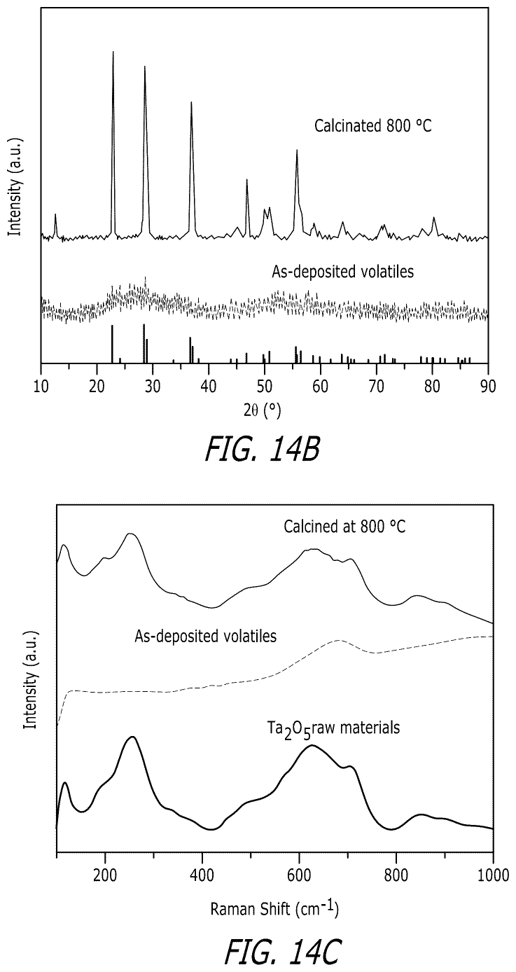

Experimentally, Ta₂O₅ was mixed with carbon (C) and conducted the ETCC reaction. FIGS. 14A-14C. Ta₂O₅ was successfully converted to volatile product, which was projected to be tantalum oxychlorides, that can be collected through evaporation-condensation process.

Similarly, SiO₂ can be converted to volatile product by the ETCC process. The carbochlorination reaction kinetics were measured, and the rate constants were obtained. For the following reactions:

SiO₂(s)+2Cl₂(g)+2C(s)=SiCl₄(g)+2CO(g) (3)

Ta₂O₅(s)+5Cl₂(g)+5C(s)=2TaCl₅(g)+5CO(g) (4)

According to the definition, the rection rate (v) is defined as:

$$v ( {SiO}_{2} ) = - \frac{Δ n ( {SiO}_{2} )}{Δ t} \qquad ( 5 )$$

$$v ( T {a}_{2} {O}_{5} ) = - \frac{Δ n ( T {a}_{2} {O}_{5} )}{Δ t} \qquad ( 6 )$$

Experimentally, SiO₂ (or Ta₂O₅) were separately mixed with C according to the stoichiometric ratio, and the carbochlorination reaction was conducted. The weight loss was measured at different reaction time (Δt), thus obtaining the corresponding Δn(SiO₂) (or Δn(Ta₂O₅)). Then, the reactions rates were calculated.

During the experiments, Cl₂ was excessively supplied and SiO₂, Ta₂O₅, and C were solid, so the above carbochlorination reactions can be regarded as zero-order reactions. Hence, the reaction rate constants (k) can be calculated by:

k(SiO₂)=v(SiO₂) (7)

k(Ta₂O₅)=v(Ta₂O₅) (8)

Assuming that the k is temperature-independent, according to the Arrhenius equation, the rate constant as a function of reaction temperature (T) is given by,

k=Ae^{-E}^{ₐ}^{/RT} (9)

where A is the pre-exponential factor, Eₐ is the activation energy, and R is the gas constant. Eq. (9) can be revised as,

$$ln k = ln A - \frac{{E}_{a}}{R} \frac{1}{T} \qquad ( 10 )$$

By plotting lnk~1/T (FIG. 12D with plots 1201-1202 for Ta₂O₅ and SiO₂, respectively), the activation energies of carbochlorination reactions were calculated to be Eₐ(SiO₂)=53.6 kJ mol⁻¹ and Eₐ(Ta₂O₅)=31.6 kJ mol⁻¹.

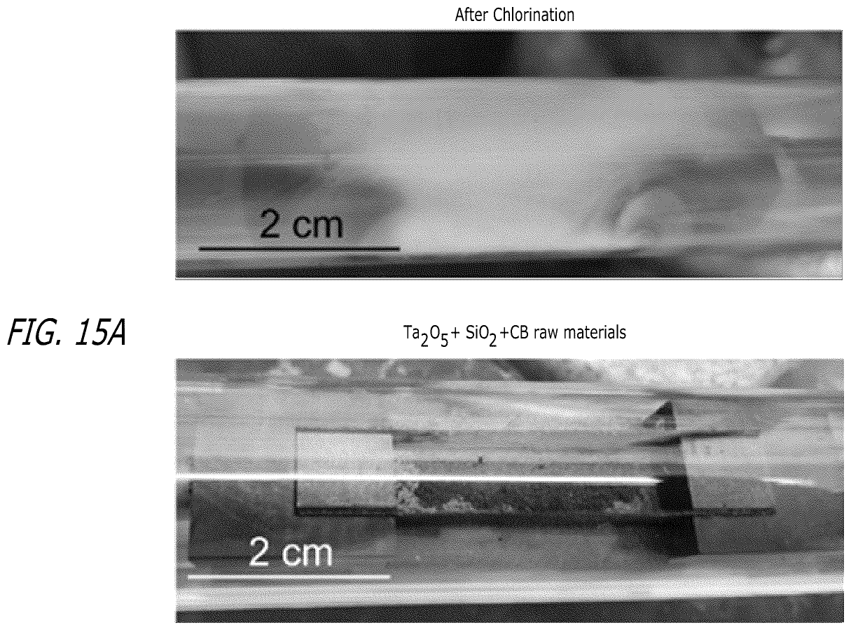

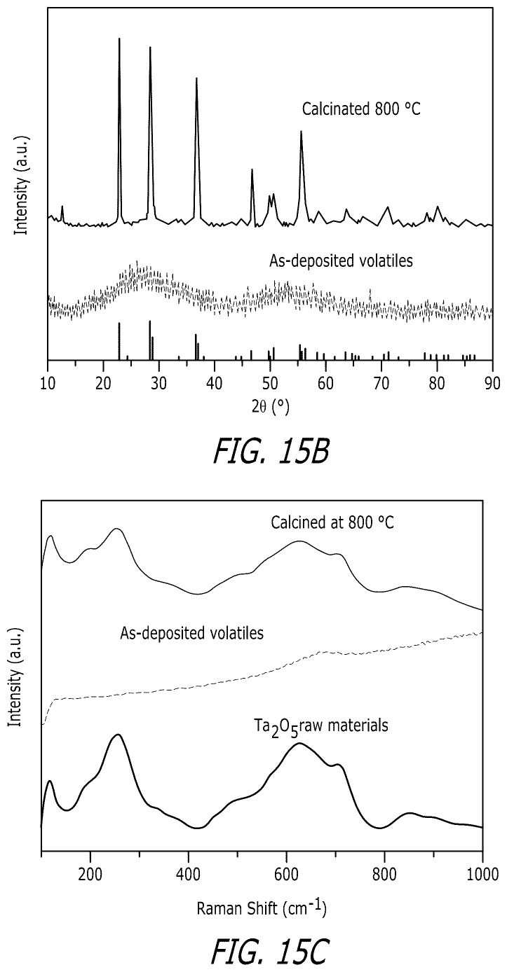

The activation energy difference enables the kinetically controlled separation of Ta₂O₅ and SiO₂. To further confirm this, SiO₂ and Ta₂O₅ were mixed with the addition of C and the ETCC reaction was conducted. FIG. 15A. By precisely controlling the voltage at 100 V and corresponding temperature at ~1050 °C, Ta₂O₅ was selectively chlorinated and separation by evaporation from the unreacted, residual SiO₂ was conducted. FIGS. 15B-15C.

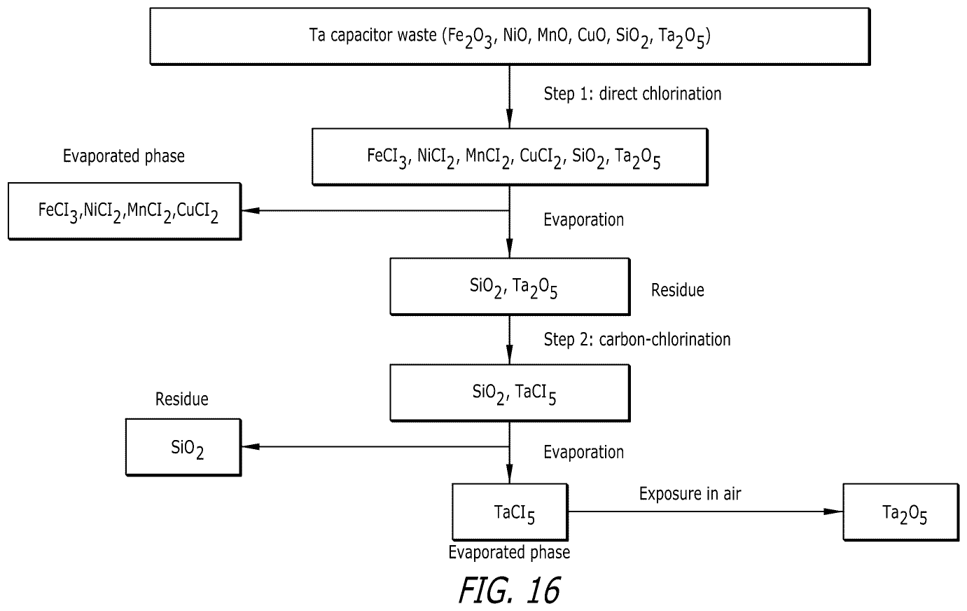

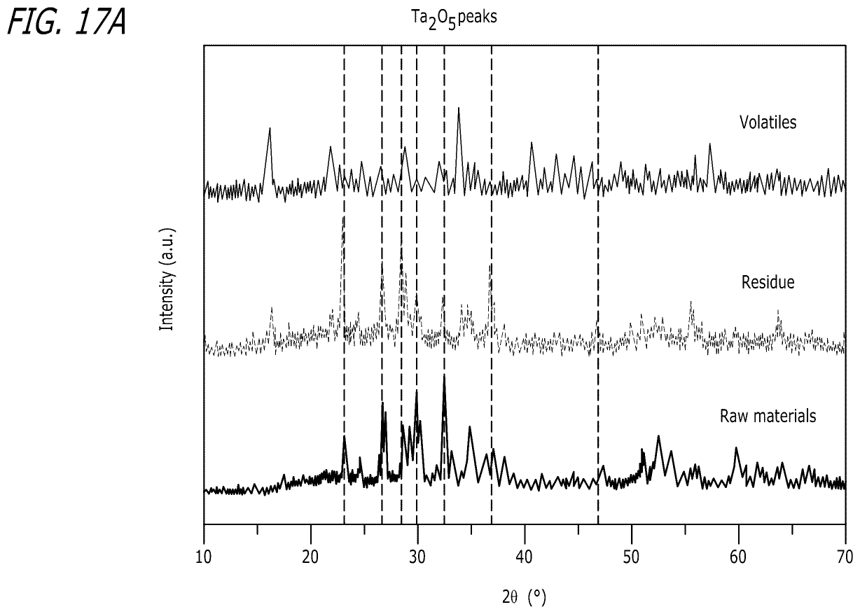

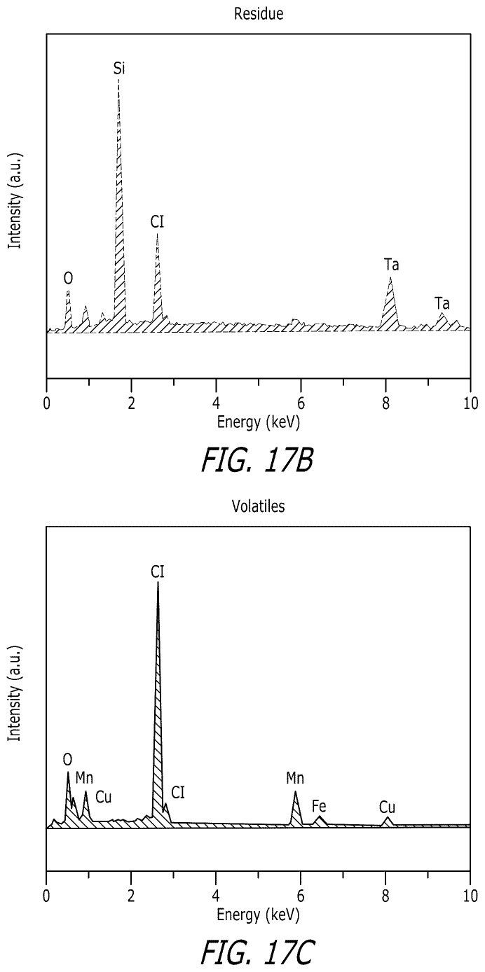

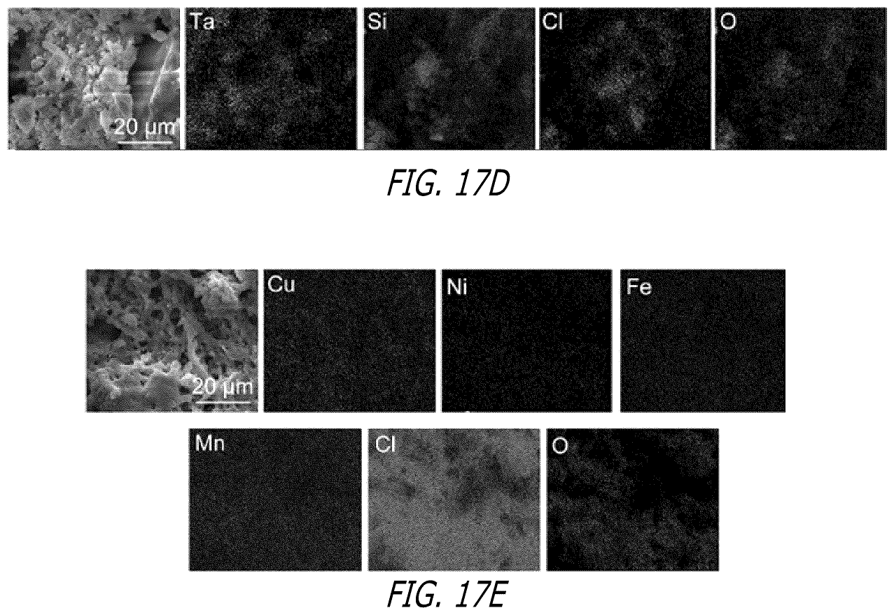

By leveraging the thermodynamic and kinetic selectivities, the two-step process can be utilized for Ta separation from capacitor waste. FIG. 16. In a typical experiment, the first step is the ETC reaction, by controlling the electrothermal temperature between ~1230 to 1380 °C, CuO, Fe₂O₃, NiO, and MnO were converted to their chlorides and evaporated as the volatile phase. The characterization of the volatile phase by elemental dispersion spectroscopy (EDS, FIG. 12E, bottom; FIGS. 17A-17E) and ICP-MS (FIG. 12F, step 1 volatile) showed the enrichment of Cu, Fe, Mn, and Ni in the volatile component. In contrast, Ta and Si were unreactive and remained in the residue phase, as confirmed by EDS (FIGS. 17B and 17D) and ICP-MS (FIG. 12F, step 1 residue). (At this point an optional water rinsing to remove small amounts of the metal chlorides can be done, but it is not required.)

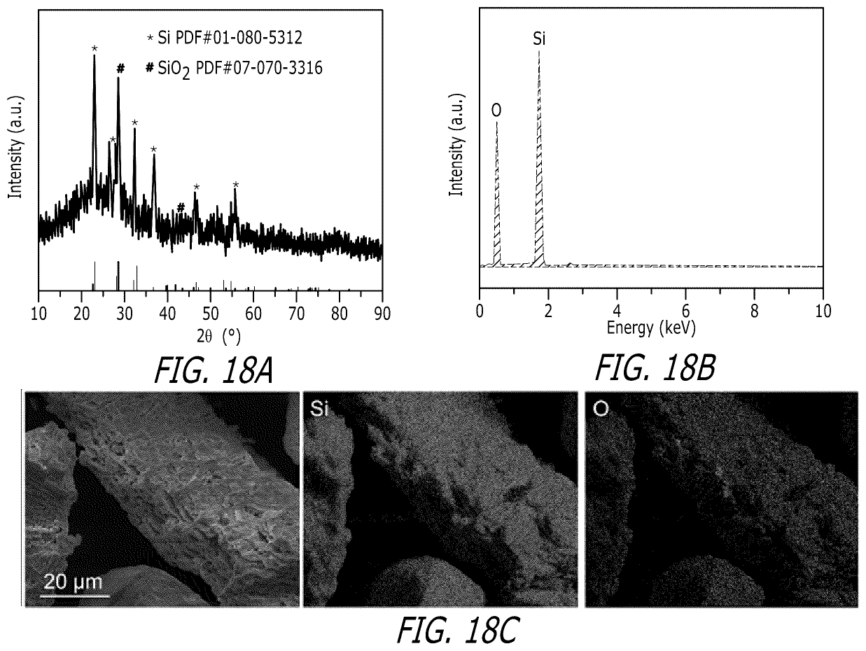

Next, in the second step ETCC reaction, the first-step residue was mixed with C (always in the form of carbon black, CB) and the reaction was conducted. By controlling the electrothermal temperature at ~1050 °C, Ta₂O₅ was mostly chlorinated and evaporatively collected as the volatile phase, as evidenced by EDS (FIG. 12E, top) and ICP-MS (FIG. 12F, step 2 volatile). In contrast, SiO₂ mostly remained in the residue phase (FIG. 12F, step 2 residue; FIGS. 18A-18C). After optimizing the voltage input and duration of the two-step process, the selective recovery of Ta from capacitor waste was achieved with 96% purity and 88% yield. FIG. 12G (bars 1211-1212 for purity and yield, respectively, at each of three different voltages or durations). The as-obtained Ta product is an amorphous mixture of tantalum oxychlorides, which can easily converted into pure Ta₂O₅ by mild calcination in air. FIGS. 12H-12I.

### Scaling Up Capability

The scalability of the electrothermal chlorination process was evaluated. The precise temperature control can play a pivotal role in the selective recovery of metals. Hence, the parameters determining the temperature were first considered. Analysis using the system shown in FIG. 3B having the RC circuit of FIG. 3A, heater resistance in Joule heating has a significant role, and there is an optimal resistance of the carbon paper heater to deliver the preferred energy conversion efficiency from electricity to heat. This value is determined by the electrical supply system, and in the system of FIG. 3B, it was determined that the optimized value is 0.5 Ohm to 2 Ohm.

Hence, when scaling up the method and system, it can be important to maintain a consistent resistance of the carbon heater. This can be readily done by maintaining the thickness and aspect ratio (defined as ratio of length to width, L/W) of the heater. The resistance of the carbon paper heater (R) is calculated by,

$$R = \frac{ρ L}{S} = \frac{ρ L}{W D} \qquad ( 11 )$$

where ρ is the resistivity of the carbon heater, and L, W, S, D are the length, width, cross-sectional area, and thickness of the carbon heater, respectively.

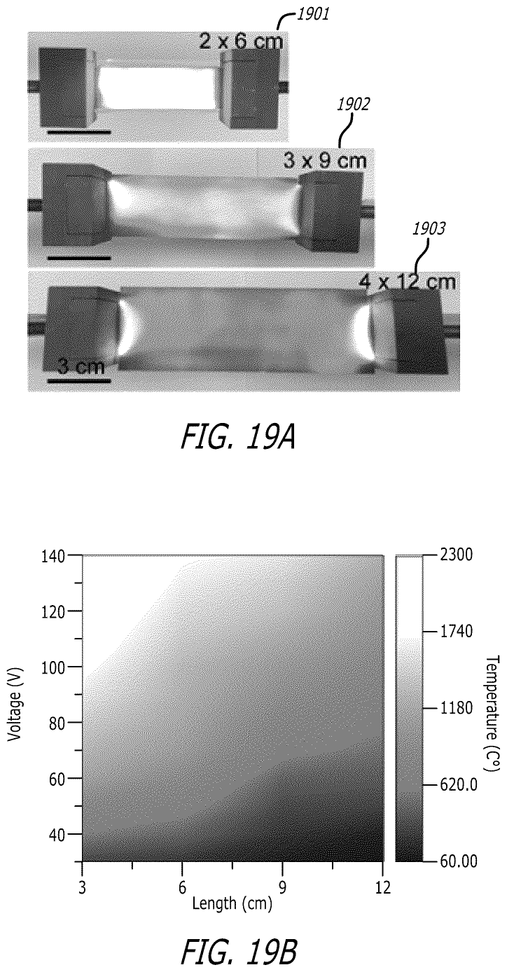

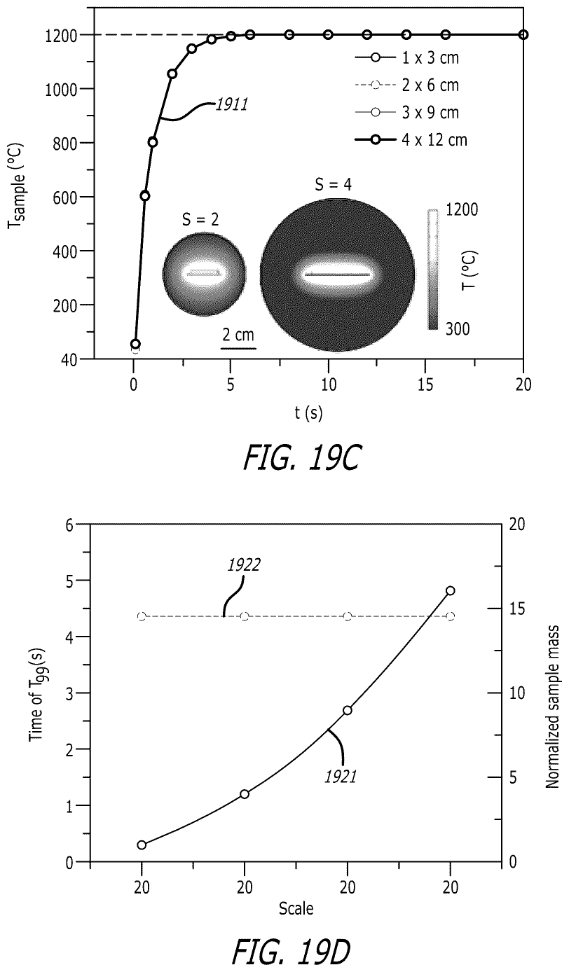

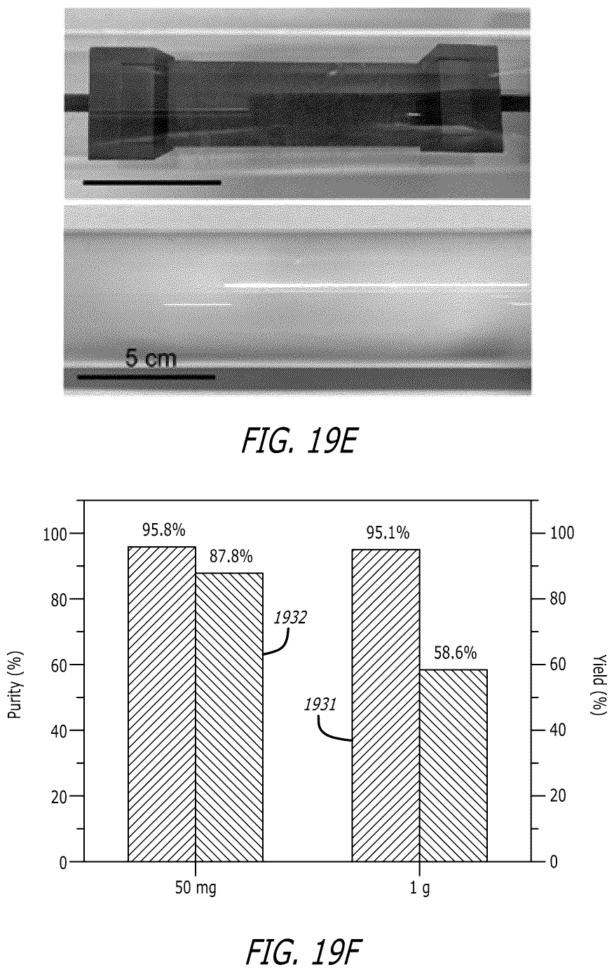

If the D and aspect ratio (L/W) of the carbon paper heater are maintained, the resistance of the carbon paper heater (R) will be kept the same. For example, when the carbon paper heater size of 1×3 cm² is used (as it was for small-scale experiments), this is denoted as scaling factor(S)=1. The resistance of this carbon paper heater (R₁) is ~0.7Ω. The process was upscaled to S=2, 3, 4. FIG. 19A, carbon paper heaters 1901-1903, respectively. (The sizes of carbon paper heaters 1901-1903 are of 2×6 cm², 3×9 cm², and 4×12 cm² (W/L), respectively). The resistance of these samples was the same according to the experimental measurement, as expected. The temperature of the carbon paper heater with different scales was measured under different voltage input. FIG. 19B. This temperature plot provides guidance on how to adjust the voltage input when scaling up the scale.

The sample temperature was regulated by the heater temperature when scaling up the sample size as studied through further simulation. The heater conduction from the carbon paper heater to the sample is determined by the Fourier's law. If a uniform temperature is assumed for the sample during heating and the sample temperature at time t is Tₛₐₘₚₗₑ, the temperature gradient (θ) is defined as:

θ=Tₛₐₘₚₗₑ−Tₕₑₐₜₑᵣ (12)

where Tₕₑₐₜₑᵣ is temperature of the carbon paper heater. Then, the temperature gradient at the initial time (θ₀) is:

θ₀=T_{sample,0}−Tₕₑₐₜₑᵣ (13)

where T_{sample,0} is the initial temperature of the sample.

According to the instantaneous heat transfer, the t required for the sample to reach Tₛₐₘₚₗₑ can be calculated by,

$$t = \frac{{ρ}_{s} {V}_{s} {c}_{s}}{h {A}_{s}} ln \frac{{θ}_{0}}{θ} \qquad ( 14 )$$

where ρₛ is the density of the sample, Vₛ is the volume of the sample, cₛ is the specific heat capacity of the sample, h is the heat transfer coefficient, and Aₛ is the heat transfer area between the carbon paper heater and the sample.

Considering that Vₛ=Dₛ×Aₛ where Dₛ is the thickness of the sample, the above Eq. (14) can be revised as,

$$t = \frac{{ρ}_{s} {D}_{s} {c}_{s}}{h} ln \frac{{θ}_{0}}{θ} \qquad ( 15 )$$

T₉₉ is defined as the time required to heat the sample to 99% of the carbon paper heater temperature (Tₛₐₘₚₗₑ=0.99Tₕₑₐₜₑᵣ), which yields,

$${T}_{99} = \frac{{ρ}_{s} {D}_{s} {c}_{s}}{h} ln \frac{{T}_{heater} - {T}_{sample , 0}}{0.01 {T}_{heater}} \qquad ( 16 )$$

Two scenarios were considered for the upscaling. The first is scaling up the sample in two dimensions (length and width, denoted 2D scale-up), and the second is scaling up the sample in three dimensions (length, width, and thickness, denoted 3D scale-up).

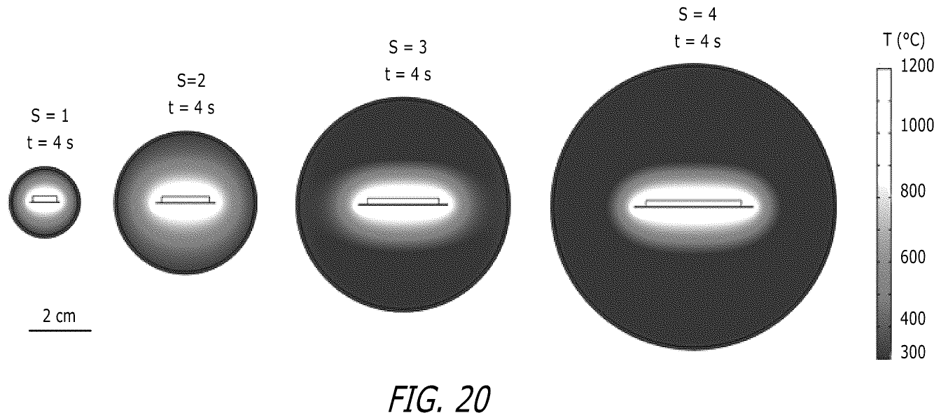

First, a two-dimensional (2D) scale-up was considered, meaning that the sample length and width is proportionally enlarged according to the dimension of the carbon paper heater, while the thickness of the sample remains the same. The temperature profiles of the sample at different scales follows a common pattern (FIG. 19C (each of S=1, 2, 3, 4 in overlapping plot 1911); FIG. 20), irrespective of the scale.

T₉₉, which again represents the time required to heat the sample temperature to 99% of the carbon paper heater temperature, can be used to quantitatively describe the dependence of the heating period on the sample scale. While the sample mass is increased exponentially (FIG. 19D, plot 1921), time of T₉₉ is independent of the sample scaling factor (FIG. 19D, plot 1922), showing an excellent scalability of the electrical heating.

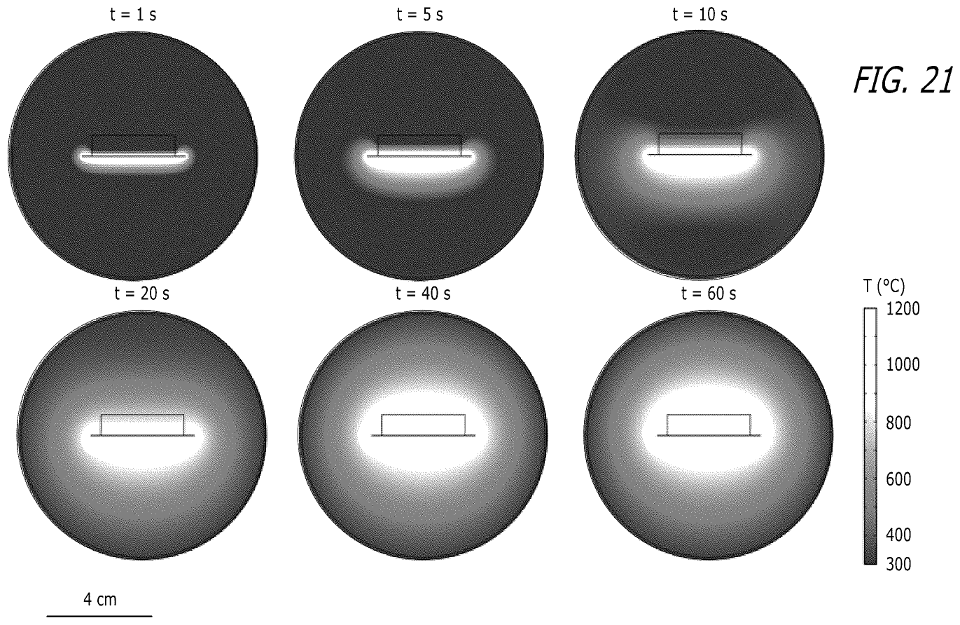

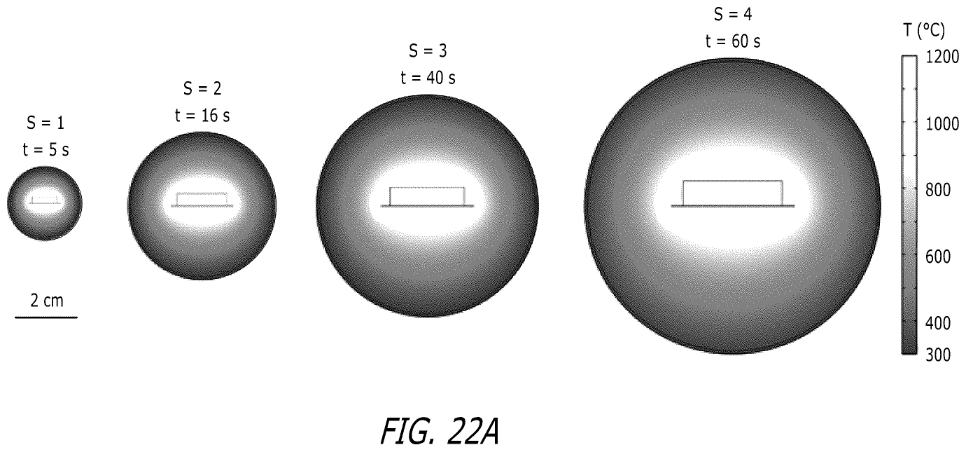

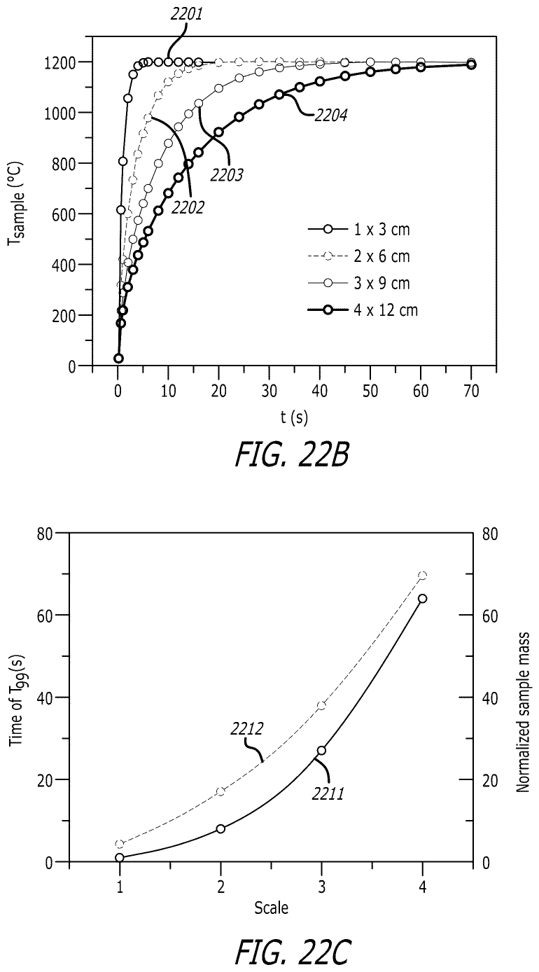

The three-dimensional (3D) scale-up was then analyzed, meaning that all three dimensions of the sample are proportionally enlarged according to the dimension of carbon paper heater. In this case, with the increase of sample scale, time of T₉₉ is synchronously increased with the sample mass. FIGS. 21 and 22A-22C. FIG. 22B shows simulated average temperature profile of sample with plots 2201-2204 for different carbon heater scale S=1, 2, 3, 4, respectively. FIG. 22C shows time of T₉₉ and the normalized sample mass varied with carbon heater scale in plots 2211-2212, respectively. Nevertheless, the temperature reaches the plateau with ~1 min for the upscaled sample (FIG. 21), still outperforming the indirect heating that could take hours to reach thermal balance. Basically, it was found that, for the 3D scale-up, a longer heating duration is required for the temperature balance of a larger S, which is determined by the rate of heat transfer. The above results show that the electric heating is especially good for the 2D scaling up.

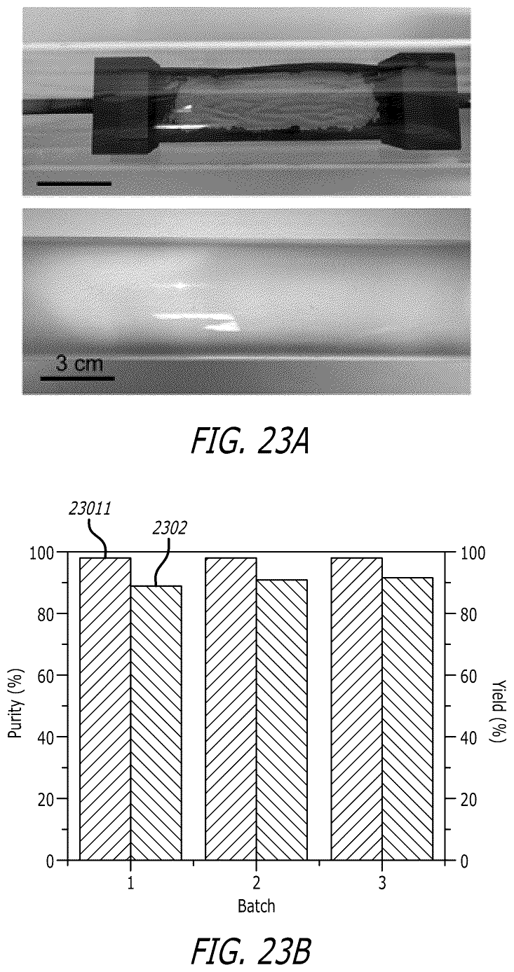

Further, the electrothermal chlorination was increased to the gram scale. A 2-inch (5.08 cm) tube reactor was constructed, and a carbon paper heater of 9 cm×3 cm (L/W) was used. The larger reactor as used for ETC of In from ITO at a 1 g scale. FIG. 23A. The overall process is the same as for the small-scale reaction. After optimization, a comparable 98% purity and 91% yield was obtained (FIG. 23B (bars 2301-2302 for purity and yield, respectively, for three different batches)), nearly the same as in the small reactor. FIG. 19F (bars 1931-1932 for purity and yield, respectively).

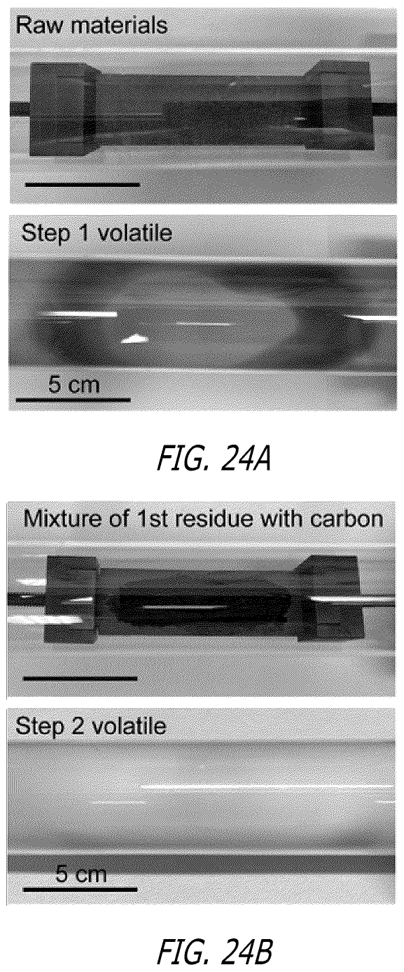

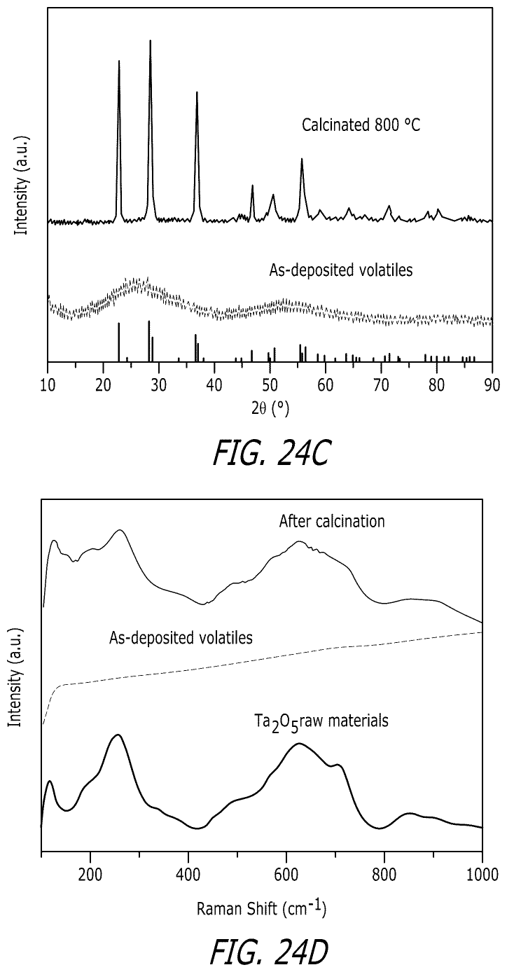

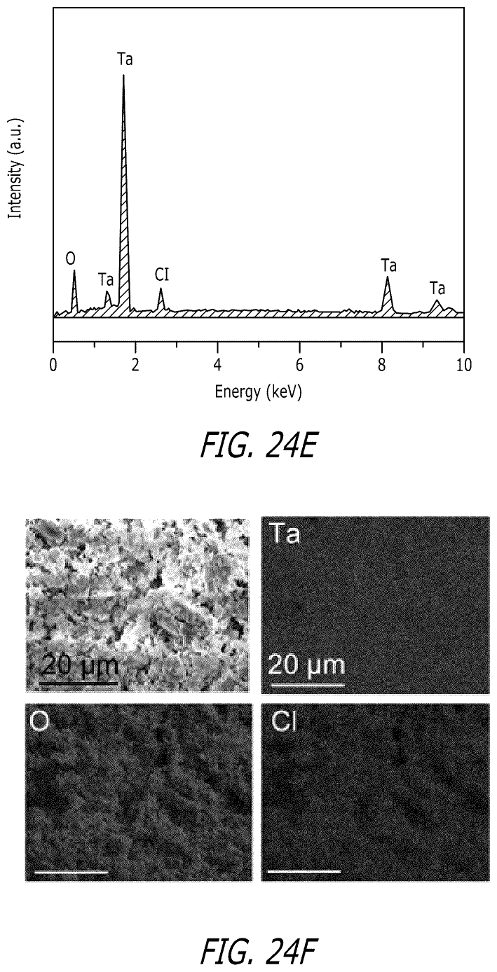

A processing time of 10 min was needed, corresponding to a productivity of 144 g per day. Then, the scale of the two-step ETC and ETCC process was increased for selective recovery of Ta from Ta capacitor waste, also at a 1 g scale (FIGS. 19E and 24A-24F), achieving a 95.1% purity but with a depressed yield due to losses downstream in the tube. Further optimization is being done by modifying the product collection system. In all cases, unreacted Cl₂ can be recycled and reused via typical industrial methods.

### Further Utilizations

ETC and ETCC can be utilized for the selective separation and recovery of technology-critical metals from e-waste. Most methods merely extract many metals at once, relying on classical wet-chemical methods that are water, acid- or base-intensive, thereby affording tailings and toxic secondary waste streams. In embodiments of the present invention, all water and acid use are mitigated. Compared to conventional chlorination processes, the introduction of electrification enables the merits including ultrahigh temperature, precise temperature control, and kinetic controllability, thus expanding the reach of chlorination metallurgy. Embodiments of the present invention can utilize ETC in selective recovery of In from ITO-containing wastes and ETC coupled with ETCC for Ta recovery from capacitor waste. Such methods and systems are scalable, revealing the utility of this approach for larger amounts. Capitalizing on thermodynamic and kinetic selectivity in a compact reactor design, the ETC and ETCC are further a harbinger for water-free and acid-free metal recycling, refining, and valorization, while minimizing the need for continued metal mining.

Furthermore, the present invention provides for metal recovery and separation systems and methods, and particularly metal recovery and separation by combining chloride processes in flash joule heating systems and methods.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments±20%, in some embodiments±10%, in some embodiments ±5%, in some embodiments±1%, in some embodiments±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

U.S. Pat. No. 5,389,353, entitled “Fluidized bed process for chlorinating titanium-containing material and coke useful in such process,” issued Feb. 14, 1995, to Hans H. Glaeser, et al. (“Glaeser '353 Patent”)
Adachi, G., Ed., Science of Rare Earths, Kagakudojin, Kyoto, Japan, 1999, 188-194 (“Adachi 1999”).
Agrawal, M., et al., “Global market trends of tantalum and recycling methods from Waste Tantalum Capacitors: A review,” Sustainable Materials and Technologies, 2021, 29, e00323 (“Agrawal 2021”).
Angerer, T., et al., “Recycling potentials of the two refractory metals tantalum and niobium,” Proceedings of EMC; GDMB: Clausthal-Zellerfeld, Germany, 2013, 1069-1084 (“Angerer 2013”).
Chauhan, G., et al., “Novel technologies and conventional processes for recovery of metals from waste electrical and electronic equipment: Challenges & opportunities—A review,” J Environ Chem Eng, 2018, 6, 1288-1304 (“Chauhan 2018”).
Cheisson, T., et al., “Rare earth elements: Mendeleev's bane, modern marvels,” Science, 2019, 363, 489-493 (“Cheisson 2019”).
Dutrizac, J. E., et al., “The behaviour of gallium during jarosite precipitation,” Can Metall Quart, 2000, 39, 1-14 (“Dutrizac 2000”).
Fang, Z., et al., “Recovery of gallium from coal fly ash,” Hydrometallurgy, 1996, 41, 187-200 (“Fang 1996”).
Frenzel, M., et al., “Quantifying the relative availability of high-tech by-product metals—The cases of gallium, germanium and indium,” Resources Policy, 2017, 52, 327-335 (“Frenzel 2017”).
Ghosh, B., et al., “Waste Printed Circuit Boards recycling: an extensive assessment of current status,” J Clean Prod, 2015, 94, 5-19 (“Ghosh 2015”).
Gupta, C. K., et al., “Extractive Metallurgy Of Rare Earths,” Int. Mater. Rev., 1992, 37, 197 (“Gupta 1992”).
Jena, P. K., et al., “Metal extraction through chlorine metallurgy,” Mineral Processing and Extractive Metallurgy Review, 1997, 16, 211-237 (“Jena 1997”).
Judge, W. D., et al., “Recent progress in impurity removal during rare earth element processing: A review,” Hydrometallurgy, 2020, 196, 105435-105474 (“Judge 2020”).
Li, F. K., et al., “Diglycolamide-grafted Fe₃O₄/polydopamine nanomaterial as a novel magnetic adsorbent for preconcentration of rare earth elements in water samples prior to inductively coupled plasma optical emission spectrometry determination,” Chem Eng J, 2019, 361, 1098-1109 (“Li 2019”).
Lou, Z. N., et al., “Acrylic acid-functionalized metal-organic frameworks for Sc(III) selective adsorption,” Acs Appl Mater Inter, 2019, 11, 11772-11781 (“Lou 2019”).
Matsuoka, R., et al., “Recycling Process For Tantalum And Some Other Metal Scraps,” Proc. TMS Fall Extr. Process. Conf., 2004 (“Matsuoka 2004”).
Niu, B., et al., “Recovery of Tantalum from Waste Tantalum Capacitors by Supercritical Water Treatment,” ACS Sustainable Chemistry & Engineering, 2017, 5, 4421-4428 (“Niu 2017”).
Niu, L.-P., et al., Fl“uidized-bed chlorination thermodynamics and kinetics of Kenya natural rutile ore,” Transactions of Nonferrous Metals Society of China, 2013, 23, 3448-3455 (“Niu 2013”).
Ogunseitan, O. A., et al., “The Electronics Revolution: From E-Wonderland to E-Wasteland, Science, 2009, 326, 670-671 (“Ogunesitan 2009”).
Reck, B. K., et al., “Challenges in metal recycling, Science, 2012, 337 (6095), 690-695 (“Reck 2012”).
Salazar, K., et al., “Mineral Commodity Summaries 2013,” U.S. D.o.t. I. U.S. Geological Survey (Ed.). U.S. Geological Survey, Reston, Virginia, Reston, Virginia, 2013, 58 (“Salazar 2013”).
Silva, R. G., et al., “Selective precipitation of rare earth from non-purified and purified sulfate liquors using sodium sulfate and disodium hydrogen phosphate,” Miner Eng, 2019, 134, 402-416 (“Silva 2019”).
Sovacool, B. K., et al., “Sustainable minerals and metals for a low-carbon future,” Science, 2020, 367, 30-33 (“Sovacool 2020”).
Uda, T., et al., “Technique for enhanced rare earth separation,” Science, 2000, 289, 2326-2329 (“Uda 2000”).
Virolainen, S., et al., “Recovery of indium from indium tin oxide by solvent extraction,” Hydrometallurgy, 2011, 107, 56-61 (“Virolainen 2011”).
Xie, F., et al., “A critical review on solvent extraction of rare earths from aqueous solutions,” Miner Eng, 2014, 56, 10-28 (“Xie 2014”).
Xing, Z., et al., “Mechanism and application of the ore with chlorination treatment: A review,” Minerals Engineering, 2020, 154, 106404 (“Xing 2020”).
Ye, Q., et al., “Solvent extraction behavior of metal ions and selective separation Sc3+ in phosphoric acid medium using P204,” Sep Purif Technol, 2019, 209, 175-181 (“Ye 2019”).
Zhang, W. J., et al., “Study on the effect and mechanism of impurity aluminum on the solvent extraction of rare earth elements (Nd, Pr, La) by P204-P350 in chloride solution,” Minerals-Basel, 2021, 11, 61-73 (“Zhang 2021”).

1. A method for selectively recovering at least one metal of two or more metals from a material, wherein the method comprises:
(a) mixing a material with an oxidant to form a mixture, wherein the material comprises two or more metals;
(b) perform a flash Joule heating process on the mixture; and
(c) separating and selectively recovering at least one or more first metals of the two or more metals of the material from at least one or more second metals of the two or more metals of the material.

2. The method of claim 1, wherein the oxidant is selected from the group consisting of chlorine agents, fluorine agents, bromine agents, iodine agents, and combinations thereof.

3. The method of claim 1, wherein the oxidant comprises a chlorine agent.

4-6. (canceled)

7. The method of claim 3, wherein the flash Joule heating process comprises an electrothermal chlorination process.

8. The method of claim 7, wherein the flash Joule heating process is performed at a temperature between 630 °C and 830 °C.

9. The method of claim 8, wherein the first one or more metals comprises In.

10. (canceled)

11. The method of claim 7, wherein
(a) the first one or more metals comprises a metal selected from the group consisting of Sn and Mn, and
(b) the second one or more metals comprises a metal selected from the group consisting of Au and Cr.

12. The method of claim 1, wherein the step of performing a flash Joule heating process on the mixture comprises:
(a) a first flash Joule heating process performed at a first temperature on the mixture to form a first product;
(b) a first evaporation process is performed on the first product to form a first residue product; and
(b) a second flash Joule heating process performed at a second temperature on the first residue product.

13. (canceled)

14. The method of claim 12, wherein
(a) the first flash Joule heating process comprises a first electrothermal chlorination process; and
(b) the second flash Joule heating process comprises a second electrothermal chlorination process.

15. The method of claim 14, wherein
(a) the first flash Joule heating process is performed at a temperature between 630 °C and 830 °C; and
(b) the second flash Joule heating process is performed at a temperature greater than 1240 °C.

16. The method of claim 12, wherein the first evaporative process forms an evaporative phase.

17. The method of claim 16, wherein the evaporative phase comprises a compound comprising In.

18. The method of claim 12, wherein the first residue product comprises a compound comprising a metal selected from the group consisting of Sn, Mn, Au, and Cr.

19-23. (canceled)

24. The method of claim 12, wherein the step of performing a flash Joule heating process on the mixture comprises:
(a) the second flash Joule heating process forms a second residue product;
(b) a second evaporation process is performed on the second product to form a second residue product; and
(c) a third flash Joule heating process performed at a third temperature on the second residue product.

25. (canceled)

26. The method of claim 1, wherein the material is a waste.

27-32. (canceled)

33. The method of claim 1, wherein the mixture further comprises a reductant.

34-41. (canceled)

42. The method of claim 1, wherein
(a) the flash Joule heating process forms a first product;
(b) a first evaporation process is performed on the first product to form a first residue product;
(c) the method further comprises mixing a reductant to the first residue product to form a second mixture; and
(d) the method further comprises performing a second flash Joule heating process on the second mixture.

43-73. (canceled)

74. A system for selectively recovering at least one metal of two or more metals, wherein the system comprises:
(a) a source of a mixture comprising a material and an oxidant, wherein the material comprises two or more metals;
(b) a cell operably connected to the source such that the mixture can be flowed into the cell and held under compression;
(c) electrodes operatively connected to pressure cell; and
(d) a flash power supply for applying a voltage across the mixture to perform a flash Joule heating process on the mixture, wherein the system is configured and operable to perform the flash Joule heating process to separate and selectively recover at least one or more first metals of the two or more metals of the material from at least one or more second metals of the two or more metals of the material.

75. The system of claim 74, wherein the source of the mixture comprises the material, the oxidant, and a reductant.

76. The system of claim 74, wherein the system comprises a second source comprising a reductant.
